(19) United States
(12) Patent Application Publication
(10) Pub. No.: US 2003/0043848 A1
(43) Pub. Date: Mar. 6, 2003

(54) Method and apparatus for data item processing control

(76) Inventor: Bradley Stephen Sonksen, Rancho Santa Margarita, CA (US)

Correspondence Address: Chad W. Miller, Weide & Associates, Ltd., Phoenix Bldg., 11th Floor, Suite 1130, 330 South 3rd Street, Las Vegas, NV, 89101, US

(21) Appl. No.: 09/944,464

(22) Filed: Aug. 30, 2001

(51) Int. Cl. H04J 3/24

(52) U.S. Cl. 370/474; 370/389

(57) ABSTRACT

A method and apparatus for packet processing is disclosed. In one embodiment of the invention the method and apparatus is implemented in plurality of pipeline stages, each stage or group of stages being configured to a particular processing operation. Each stage may operate simultaneously, if data is available, and independently. Common data or control words are shared between the various stages of the pipeline to provide control an supplemental data to each processing stage in the pipeline. In one embodiment the processing pipeline includes one or more dynamic stages and one or more static stages. The dynamic stages are configured to modify, remove, or supplement portions of the packet as the packet or portion thereof passes through the pipeline with the aid of a more flexible control structure. The static stages are configured to modify, remove, or supplement portions of the packet as the packet or portion thereof passes through the pipeline with the aid of a hardwired system. A control system is associated with the packet processing system. The control system includes a central portion and a distributed portion that is associated with each pipeline stage. High speed operation is achieved through the use of hardware based operation while processing flexibility is provided by control word association at each processing stage.

### FIELD OF THE INVENTION

The present invention relates to data processing devices and in particular data processing devices in a packet-switched network.

### BACKGROUND OF THE INVENTION

Computer networks are a popular and integral part of modern communication and computer systems. Numerous computer networks utilize packet architecture to exchange data between computers and between other networks. Packet architecture or packet switched networks group outgoing data into a plurality of packets. In most instances, each packet includes a payload portion, containing the data, proceeded by a header portion, containing information about the packet such as the source and destination of the packet, quality of service, packet size and other information.

To send the packet between computers various network devices, such as a router, analyze the header of the packet and determine the packet's final destination or next hop. Often the packet is forwarded through more than one router before reaching its destination address. At each hop the router or other device must analyze and process the header information. This can be a complicated process as different packet formats may be used in a network. Each packet format may locate at a different position in the header the information needed by the router to properly forward the packet. This process consumes time and hence can slow the route process in high speed routing devices. This can impact the latency and ultimately the throughput of the router/network.

There exists a continuing desire to increase the speed at which packet switched networks exchange data. To meet the demand for increased network speed, there is a desire to increase the speed at which routers analyze, process, and forward the packets. The ultimate goal of a router is to analyze, process and transmit packets at the maximum rate at which they can be received, or the line rate. This can be referred to as wire-speed operation.

Numerous methods have been proposed to increase the routing efficiency and packet processing speed. One method of increasing routing speed is to attach additional data in front of the header and use this information to efficiently route a packet. This additional data is often referred to as a tag. The tag is formed of protocol data that may be utilized by the router to more rapidly analyze and route the packet. The application of a tag for routing purposes is used to support MPLS as well as other protocols. While attaching a tag to the front of a packet as a method may enable simpler routing, it suffers from several disadvantages as a result of the prior art method of creating the tag. As understood by those of skill in the art, there is a need for a router to be able to process and route packets assembled under any network protocol including but not limited to IPv4, IPv6, or MPLS. In general, the prior art method of router packet processing operation comprises use of a processor or CPU and memory to store the packet, analyze the packet, manipulate or edit the packet, restore the modified packet in memory, and then forward the data. Even if these instructions can be executed on each clock cycle, the number of instructions required a CPU-based packet processor and the speed at which they can be executed severely limits the throughput of the system. Multiple CPUs can be used to overcome the performance flaws, but this is inefficient and leads to much higher system cost and resource requirements (board space, power . . . ). For example creating or placing a tag or other data modification comprises analyzing the packet using software to obtain information about the packet and then performing a data base look-up to obtain a desired tag. One look-up method comprises a table look-up such as in a table of data stored in a memory. The processor and CPU methods utilize software to guide operation on the CPU. The CPU includes a wide variety of programmability. However, this level of programmability comes at the cost of limited performance.

FIG. 1 illustrates an example apparatus of the prior art. A packet memory 100 stores packets for processing. Input and output lines connect to the packet memory 100 for packet ingress and egress. A memory interface 102 interfaces the memory to a processor 104. The processor executes software code in a manner known for processors. The processor 104 utilizes processor memory 106 for storage of processor instructions and packets during packet processing. Packets or packet data may be input to the processor 104 and output from the processor.

In operation, described in prior art FIG. 2, the system of FIG. 1 receives and stores an incoming packet in memory. This occurs at a step 200. Thereafter, at a step 204 the processor requests the packet from memory so that analysis and may be performed on the packet. At a step 208, the processor receives the packet. The packet may be stored in processor memory. At a step 212, the processor analyzes the packet and performs packet processing on the packet as is controlled by the software running on the processor. Thereafter, at a step 216 the processor modifies the packet as determined by the analysis and in accordance with the software running on the software. As is commonly understood, software code executes in a sequential fashion with one line of code completing before the next line of code is executed. At a step 220 the processor re-writes the modified packet to memory 220. At a step 224 the prior art system forwards the packet from packet memory to a next hop destination.

As is commonly understood, reading from memory and writing to memory requires clock cycles (time). Hence for time sensitive applications, it is desirable to reduce memory read/write operations. Moreover, the processor method of executing a single software code line at a time suffers from the disadvantage of non-parallel processing in that before the next line of code can execute, the previous line of code must have completed its operation. Thus, even though a processor can be designed to optimize certain operations, its optimization is also limited by the level of flexibility that it is designed to retain.

By way of example, this processor based method for creating or obtaining a tag, suffers from several disadvantages. One disadvantage is that because the Tag is stored in memory, it requires an undesirably long period of time or number of to obtain the Tag from memory, additional cycles to process the packet to obtain the tag, and yet more cycles to write the packet with the tag back into memory. In packet processing devices that route packets at or near the rate at which packets are received by the device, the undesirably long period of time to obtain and attach the tag may act as a bottleneck and slow device operation. Also, since many processor operations may be required, the sequential nature of processor code execution requires a large number of dedicated processor units in a high performance system in order to achieve the high degree of parallelism required for high throughput. Parallel CPUs used for this application lead to large, inefficient, power-hungry and costly systems.

Moreover, the prior art was disadvantaged in numerous other ways by the use of a processor based system executing software code. Any modification or analysis of the packet required an undesirably large number of processing cycles. As a result such system are unable to operate at high speed.

The invention overcomes the disadvantages of the prior art by providing a new method and apparatus for pipelined packet processing to perform a wide variety of packet processing tasks with high system throughput including but not limited to tag operations and TTL/check sum operations.

### SUMMARY OF THE INVENTION

The method and apparatus described herein comprises a method and apparatus for packet processing and controlling the same. In one embodiment an the method and apparatus is enabled in an ASIC-based solution to thereby maximize performance and efficiency while still enabling sufficient flexibility to implement a high performance and high flexibility device.

In one embodiment the a method and apparatus is configured to dynamically supplement, modify, or remove data contained in a packet. The term packet includes the header or tag information of a packet in addition to any user data associated with packet. In one embodiment the invention comprises a method for dynamically modifying a packet using a pipeline processing system that stores a portion of the packet in a register such that the register is accessible by a multiplexer. The method also stores supplemental data in a memory. It is contemplated that the supplemental data is accessible by the multiplexer. The method also includes clocking data from a portion of the packet and the supplemental data into the multiplexer and controlling the multiplexer with control instructions to selectively output a portion of the packet and/or a portion of the supplemental data to generate a dynamically modified packet.

It is further contemplated that the control instructions may comprise microcode that is generated by a user of the pipeline processing system. The method may also include analyzing an output from a progress counter to determine multiplexer output. In one embodiment the supplemental data comprises a control word and the memory comprises a control word bank. In one embodiment the supplemental data comprises label data and the portion of the packet comprises four bytes. The pipeline processing system may include two or more stages and further include generating control data at each stage to distribute control operations at two or more stages.

In another method of operation, the invention may comprise a method of adding a tag to a packet comprising identifying a control word to guide processing of a packet and then storing a portion of a packet in a memory. Thereafter, the method selectively outputs, based on the control word and a sequence of related control store instructions, either of a portion of the packet or a portion of tag data to generate the packet with a tag attached.

Variation or additions to this method include the additional step of accessing an output of a byte counter to determine the location at which to insert tag data and/or the step of accessing label data to obtain additional tag data. In one embodiment the memory comprises a register. In one embodiment the method occurs in a pipeline processing system configured to pass an entire packet through the pipeline processing system and selectively add a tag to the packet.

The invention may also be realized as a system. In one embodiment the invention comprises a system for dynamically modifying or supplementing the contents of a packet on a packet by packet basis including a first memory configured to store a control word, a second memory configured to store a portion of a packet, and a third memory configured to store data selector control instructions. A data selector in communication is also included to communicate with the first, second, and third memories and configured to output data from the first memory or data from the second memory based on the data selector control instruction from the third memory.

In various embodiment the second memory comprises a register, and/or the data selector comprises a multiplexer. One embodiment further includes a data counter having an output connected to the data selector that controls when the data selector should output data from the first memory. One embodiment further includes a fourth memory configured to store additional data for use in modifying or supplementing the contents of the packet when the control word does not contain the desired data. It is further contemplated that the data selector control instructions may comprise microcode.

In yet another embodiment the invention modifies a packet based on control instructions and includes a pipeline processing stage comprising one or more memory modules configured to store packet data and supplemental data. It also includes a processing module configured to add supplemental data to a packet or strip data from a packet based on control instructions and the processing location in the packet. The system also includes a control system comprising a packet location tracking system configured to track the current processing location in the packet and a memory bank configured to store control instructions. In one embodiment the processing module is further configured to modify data in a packet or decrement a byte of data in a packet. One embodiment includes an interface configured to interface the pipeline processing stage with the control system.

It is contemplated that the process of adding supplemental data, stripping data, and replacing data may occur at any location in a packet. Furthermore, the packet location tracking system may comprise a counter. In another embodiment the system further includes an end of packet monitoring system configured to detect the end of a packet and reset the packet location tracking system. In yet another configuration, the system further includes a control instruction selection system configured to identify which of a plurality of control instructions are for use by the pipeline processing stage. It is possible for the control instruction selection systems to comprise a packet counter configured to provide an output to the processing stage to indicate a location in the memory bank at which the control word for the packet is located. The control word then serves to select one of many groups of control instructions.

Another aspect of the method and apparatus described herein is the ability to process data as it is passing through a packet processing pipeline to modify or replace packet data, or to change the order of data within the packet, including the header or a tag. One embodiment of the system is used for modifying a portion of a packet and comprises a first data storage having two or more storage locations, a first set of one or more data selectors connected to received the output of at least one of the two or more storage locations. It also includes one or more data modifiers connected to receive the output of at least one of the first set of one or more data selectors and configured to create modified data and a second set of one or more data selectors connected to receive the modified output of at least one of the one or more modifiers. Additionally, there is a second data storage having two or more storage locations wherein the second data storage is configured to store the output of at least one of the second set of one or more data selectors.

In one embodiment the first set of one or more data selectors is configured to direct the data from any one of the two or more storage locations of the first data storage to any of the one or more data modifiers and the second set of one or more data selectors is configured to direct the modified data to any of the two or more locations of the second data storage. It is contemplated that the first data storage and the second data storage may comprise a four byte register and each storage location is one byte in size. The data selectors may comprise multiplexers and the system may further include a control system configured to determine when the data modifiers modify the data received from the first set of one or more data selectors. It is further contemplated that the control system may be further configured to provide one or more data selector control signals to the first and second set of one or more data selectors to thereby control the routing of data to the data modifier and the two or more locations of the second data storage. The one or more data modifiers may perform modifications consisting of modification to a time to live value, a type of service value, a checksum value, or other data fields in a packet.

In one method of operation, the method may comprise a method for selectively modifying a portion of a packet as portions of the packet pass through a packet processing system including analyzing the packet to determine processing instructions for the packet, storing the processing instructions in a first memory, loading a portion of a packet into a processing module, providing control instructions to the processing module, processing the portion of the packet with the processing module to create a modified portion of the packet, and outputting the modified portion from the processing module. The processing may modify a portion of the packet.

The method may further include tracking the number of portions of the packet that have passed through the processing module to thereby control when the processing module will modify a portion of the packet. In one configuration storing the processing instructions in a first memory occurs at a location defined by a counter output. The processing module may perform time to live modification or type of service modification. It is contemplated that the method further include sequentially passing a plurality of packet portions into the modify unit to generate a running summation of portion values to thereby generate a new checksum value.

A control system is also provided for the method and apparatus described herein. In one embodiment control system for controlling operation of a pipelined packet processing system having two or more stages is provided wherein each of the two or more stages may process a different portion of a packet and packets are being sequentially processed in the pipeline processing system. This system may include a control word bank having two or more locations. The locations in the control word bank may be configured to store control words such that each packet is associated with a control word. The control system also includes a packet counter having an output wherein the packet counter output comprises an address to a location in the control word bank. The control system may also include a byte counter having an output comprising an offset in the packet at which processing on the packet is occurring and a control module configured to receive the packet counter output and the byte counter output. It is configured to access the control word bank to thereby selectively provide data to at least one stage of the pipelined packet processing system to control processing of the packet in at least one stage.

In one embodiment the control system is further configured to access control store instructions and the packet counter and the byte counter are associated with each of the two or more stages. It is contemplated that the pipeline processing system is configured to add, modify or strip data from a packet. A multiplexer control system comprising a multiplexer control logic and multiplexer control instruction memory may also be included. The control logic is configured to control operation of one or more multiplexers based on the multiplexer control instructions stored in the multiplexer control instruction memory.

In one embodiment the pipelined processing system is configured to attach a tag comprised of tag data to the packet, the tag data being obtained from the control word associated with the packet, a label, a control store instruction, or any combination of the control word, label, or control store instruction. The control word bank may have a write pointer that is incremented after each write. The control system may further include memory configured to store a label such that the label is accessible by the control module.

In one embodiment the control system is for a packet processing system with multiple stages wherein each stage receives a portion of a packet at a time and the control system comprises a processing location tracking system configured to generate tracking data regarding which portion of a packet a stage is processing. The control system also includes control word storage having two or more storage locations configured to store two or more control words, a control word identification system configured to provide a pointer to a location in the control word storage and an interface configured to selectively provide tracking data and control word data stored at a location identified by the pointer to a stage.

Various methods of operation may also be enabled. In one method of operation, the method controls when a processing module will perform processing as a packet passes through a packet processing pipeline. The method comprises resetting a counter having an counter output upon detection of a new packet received at the processing module and then incrementing the counter upon passage of portions of the packet. Thereafter the method compares a portion of control data associated with the packet to the counter output and may initiate operation of the processing module if the comparison reveals a match between the portion of the control data and the counter output. The comparison may be performed by a hardwired comparator. The portion of the control data may comprise data defining an offset from the start of the packet at which processing on the packet is to occur.

It is further contemplated that the method further include analyzing the packet to determine a packet protocol and selecting control data based on the packet protocol. The packet protocol may consist of IPv4, DiffServe IPv4, or IPv6. The method may occur in a plurality of processing modules in a plurality of packet processing pipelines in a packet router.

The method may further include incrementing a second counter upon receipt of the new packet such that the second counter has an output comprising an address to a memory, storing the control data in the memory at the address generated by the second counter, and providing the address to the processing module to thereby direct the processing module to the control data associated with the packet being processed by the processing module.

In an additional method of operation, the method selects between two or more control words when processing a packet at each processing stage as the packet passes through a packet processing pipeline. This method comprises receiving the packet at a processing stage in a packet processing pipeline and modifying the output of a tracking system upon receipt of the packet at the processing stage. This method stores a control word at one of two or more locations in a control word bank, such that one of the two or more locations are defined by the output of the tracking system. Next, the system provides the tracking system output to the processing stage, wherein the tracking system output selects which control word the processing stage will use. More than one processing stage may concurrently utilize the same control word due to the packet being concurrently processed by more than one processing stage. The control word may comprise between 1 byte and 2048 bytes of data.

In another variation, the processing stage comprises a dynamic processing module or a static processing module. The tracking system may comprise a counter associated with the processing stage such that the counter is configured to increment upon receipt of packet or upon the end of a packet at the processing stage. The method may also include storing associated packets and control words prior to entry of a packet into the processing pipeline. The features and embodiments described herein may be combined, implemented or claimed alone or in any combination. Further objects, features, and advantages of the present invention over the prior art will become apparent from the detailed description of the drawings which follows, when considered with the attached figures.

### DESCRIPTION OF THE DRAWINGS

FIG. 1 illustrates a block diagram of a prior art system.

FIG. 2 illustrates an operational flow diagram of a prior art method of operation.

FIG. 3 illustrates a block diagram of an example embodiment of a pipeline packet processing system of the invention.

FIG. 4 illustrates a block diagram of an example embodiment of a pipeline packet processing system with a plurality of pipelines.

Figure 5A illustrates an example implementation of pipeline processing system including dynamic processing and static processing.

FIG. 5B illustrates an example configuration and content of a storage device.

FIG. 6 illustrates a block diagram of an example embodiment of a tag generation system.

FIG. 7 illustrates an operational flow diagram of an example method of operation of a tag generation module.

FIG. 8 illustrates an example implementation of one example embodiment of the tag generation module.

FIG. 9A illustrates an example of a packet.

FIG. 9B illustrates an example header.

FIG. 10 illustrates an example of a packet having a tag.

FIG. 11A illustrates an operational flow diagram of an exemplary method of inputting to and outputting to a buffer.

FIG. 11B illustrates an operational flow diagram of an exemplary method of operation of the dynamic processing module, such as a tag module.

FIG. 12 illustrates the possible outputs of switch or multiplexer during a cycle of operation.

FIG. 13 illustrates an a block diagram of an example embodiment of checksum generator.

FIG. 14 illustrates a first storage unit feeding into a second storage unit.

FIG. 15 illustrates a checksum generator having a first and second output.

FIG. 16 illustrates an implementation example of the systems of FIG. 14 and FIG. 15.

FIG. 17 illustrates an example embodiment of a data modifier system as may be contemplated for use with a pipeline processing system.

FIG. 18 illustrates an alternative embodiment of a data modifier system.

FIG. 19 illustrates a flow diagram of an example method of operation of a data modifier system.

FIG. 20 illustrates an exemplary flow diagram of an example method of data selection for data insertion.

FIG. 21 provides an exemplary embodiment of an example configuration of a control system or control module.

FIGS. 22A-22B illustrates an operational flow diagram of an example method of operation of a control module.

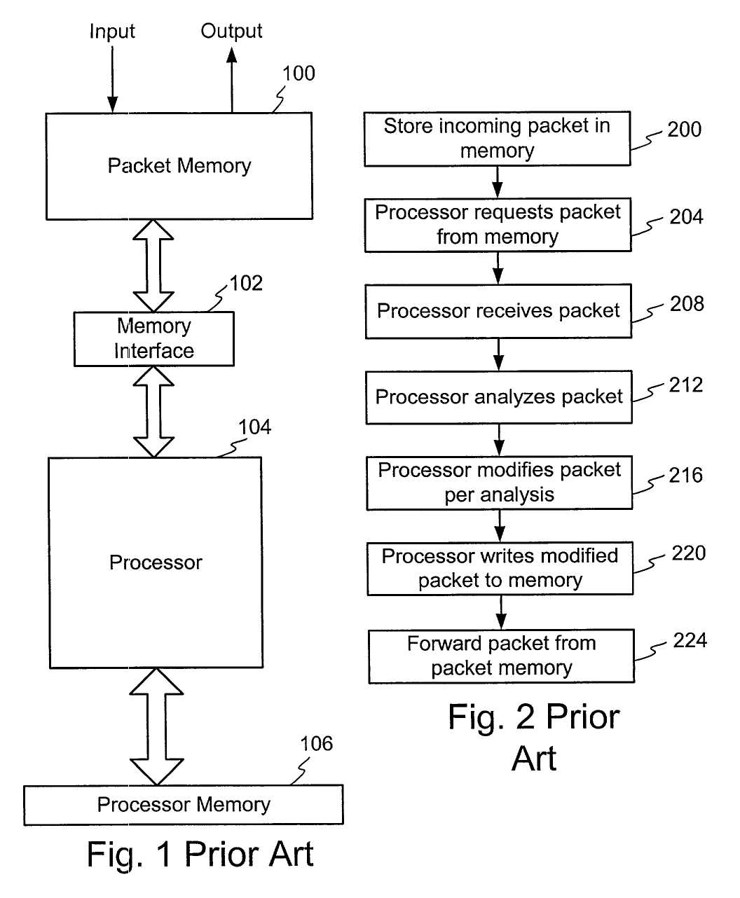

### DETAILED DESCRIPTION OF THE INVENTION

The invention is a method and apparatus for data item or packet processing. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention. It is understood that the features and elements described below maybe exist alone as in any combination.

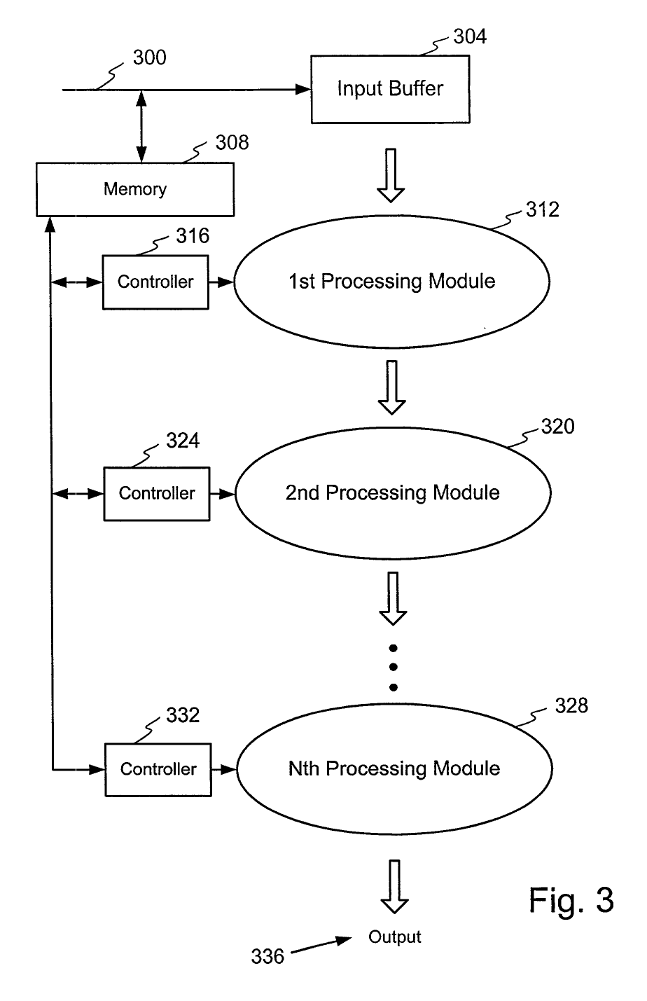

In contrast to the packet processing apparatus of the prior art that is centered around a processor running software code, the example embodiment of the invention shown in FIG. 3 illustrates a pipeline configuration having a configuration to perform multiple processing operations of the packets during a single clock cycle. This may comprise a hardware controlled implementation. As shown in FIG. 3, an input line 300 receives packets and/or control information to be processed by the pipeline operation. The term ‘packet’ is defined to mean any group or set of data that is processed by a processing device to facilitate communication between devices either within a single device or across a distance over a network or other communication channel and includes but is not limited to frame, cell, byte, word, double word, datagram, or the like. The term packet should be understood to encompass the data payload portion and the header portion of a packet, along with any tags attached to the front or back of the packet. The terms packet and data item as used herein should be considered to mean a group of data. The input line connects to a input buffer 304 and a memory 308. In one embodiment the input line 300 may carry packets and associated control data to the memory 308 for storage. Alternatively the packet data may proceed directly to the input buffer 304 while control instructions are routed to the memory 308. In another embodiment the packet and control instructions and both initially stored in memory 308 and thereafter data for processing routed to the input buffer 304.

The output of the buffer feeds into a pipeline comprised of a number of processing modules 1−N. Shown in FIG. 3 is a first processing module 312, a second processing module 320 up to an Nth processing module 328. The processing module may have a controller associated therewith to aid or provide instructions to the processing module. The control may utilize control words and control store instructions to guide operation of each module. The term control word should be not be interpreted as being limited to only an amount of data the size of a word (16 bits). The control word can comprise any amount of data. According, a first controller 316 connects or communicates with the memory 308 and the first processing module 312. A second controller 324 connects or communicates with the memory 308 and the second processing module 320. A third controller 332 connects or communicates with the memory 308 and the Nth processing module 328. The controllers 316, 324, and 332 access control instructions from the memory 308 or store control instructions received from the memory to dictate or aid processing of the packet as it progress through the processing pipeline created by the first processing module 312 through the Nth processing module 328. The Nth processing module 328 has an output 336.

In operation the data is received on the input 300. It is stored or buffered in some combination in either or both of memory 308 and input buffer 304. To facilitate processing the data is transferred down the pipeline into module 312. Corresponding control store instructions are provided to controller 316 from memory or a memory pointer to the control store in memory is provided to the controller. The first processing module 312 processes the data in accordance with the controller 316. As the first processing module 312 processes the data from the input buffer 304 it receives additional data. In one embodiment groups of bytes are sequentially provided to the first processing module 312. As processing is completed on a first byte or set of first bytes, additional bytes are provided to the first processing module 312. As data is finished being processed by the first processing module 312, the data progresses down the path to the second processing module 320. Thus, the second processing module 320 conducts processing on data simultaneous with other data processing being processed by the first processing module 312. Operation continues in this manner through the pipeline to the Nth processing module 328.

It is contemplated that data may be passed in any quantity, such as in quantities of bits, bytes, words, or entire packets. Advantageously, concurrent processing of data occurs at each stage in the pipeline. A generally continuous stream of packet data is continually loaded into the pipeline and a generally continuous stream of packet data is output from the pipeline at the output 336. Gaps on valid data may occur. At each state of the pipeline, a controller 316, 324, 332 direct appropriate processing of the data. The pipeline is also able to accommodate gaps between data or invalid data. In addition, the embodiment of FIG. 3 provides flexibility by allowing for dynamic interface from the control instructions stored in memory to at least partially control the processing of the data, via the controller, at each stage of the pipeline. Each pipeline stage controller may operate on a different set of control store instructions.

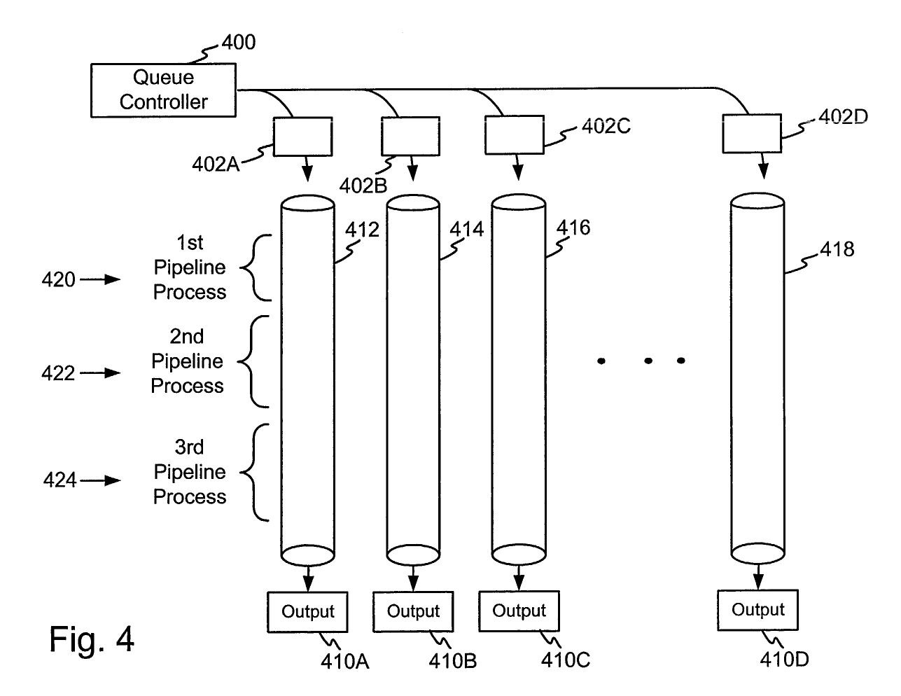

FIG. 4 illustrates another embodiment having two or more pipelines. In one implementation of this embodiment each pipeline may be considered a queue. As shown, a queue controller selectively assigns packets to a buffer 402A-402D. The buffers 402A-402D connect to two or more processing pipelines 412, 414, 416, and 418. The output of each pipeline 412, 414, 416, and 418 connects to an output system 410A-410D designed to perform additional processing on the packets and thereafter transmit the packets over a network interface (not shown). In one embodiment the output system 410 comprises a line driver. In another embodiment the output system 410 comprises a physical level interface.

At various stages of the pipelines, different processing stages 420, 422, and 424 exist to perform desired processing of the packets, i.e. data passing through the pipeline. It is contemplated that different pipelines may have different processing to accommodate the particular requirements of a queue.

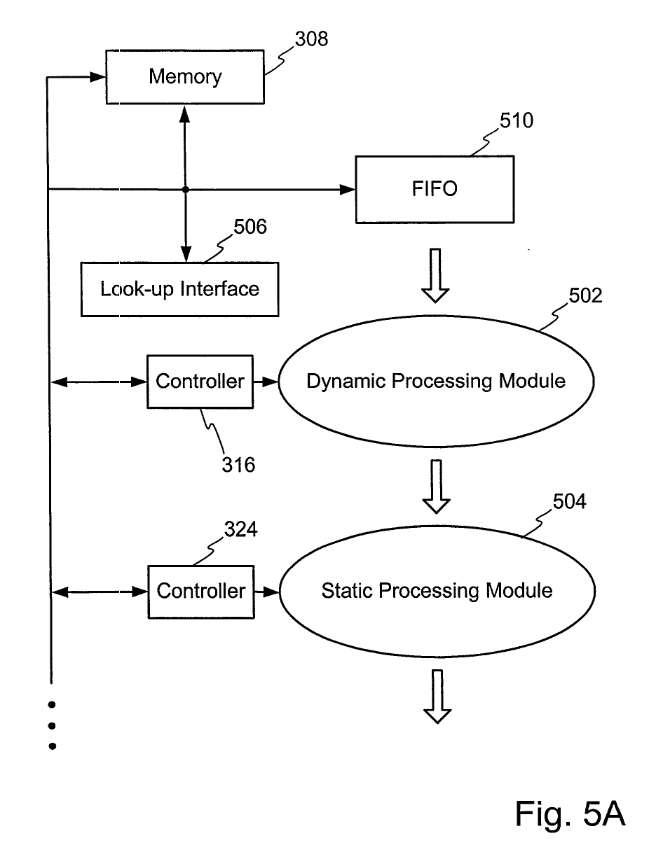

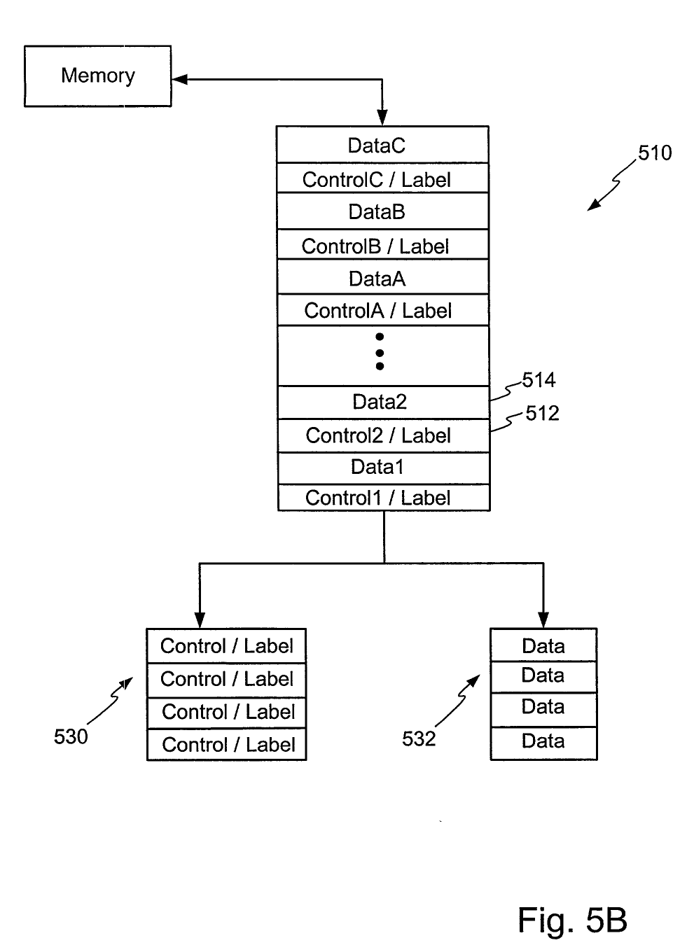

FIG. 5 illustrates one example implementation of the invention wherein the first processing comprises a dynamic or programmable tag processing module and the second processing module comprises a static processing module that is dedicated to performing a limited set of specific hardwired operation. The hardwired operation may be supplemented with flexibility enhancing logic or code. Other embodiments reverse the order of these modules. These are described below in more detail.

As shown, FIG. 5A is generally similar to FIG. 3 and illustrates a dynamic processing module and a static processing module. The dynamic processing module 502 and the static processing module 504 are part of the processing pipeline. The dynamic processing module 502 comprises a module that may be configured to generate or modify a tag or other portion of a packet header, such as a tag that may be attached to a portion of a packet to aid in packet processing or routing. The static processing module comprises a module dedicated to modifying or updating the TTL, TOS, error control portions, or any other portion of the packet data to reflect changes to the packet. Either of the modules 502, 504 may comprise any configuration of hardware, firmware, logic, and/or memory configured to achieve the processes described herein. The static processing module may be configured to support modification of packet header fields for IPv4, IPv6, or other data types.

Also shown in FIG. 5A is a look-up interface 506 and the input buffer embodied as a first-in, first-out storage device 510 (FIFO). The look-up interface 506 an interface configured to perform a look-up for data that may be used to control processing of the packet as it passes through the pipeline.

FIG. 5B illustrates an example configuration and content of the FIFO 510. In one embodiment as shown in FIG. 5B, the FIFO 510 contains data information and control information. In one embodiment the control information in the FIFO 510 includes label data. The adjacent data and control information may be associated such that control2 512 is associated with data2 514. In one embodiment the data comprises a packet and the control information comprises a packet handle or a control instruction. Control and data information may be interleaved in many ways as long as the control information for a particular packet is associated with the correct packet data.

The output of the FIFO 510, may be separated into a control storage 530 and data storage 532. The control/label storage 530 and data storage 532 may comprise FIFO units. In this manner associated control information and data may be separated and retrieved as desired by other processing aspects of the system, such as the pipeline processing stages. In one embodiment the control/label storage 530 is written like a FIFO, but all locations are simultaneously viewed by various packet processing stages to enable a high degree of parallelism in the packet processing operations. It is desired to maintain an association between the associated data and control information. In one embodiment the storage 510, 530, 532 serves as buffers.

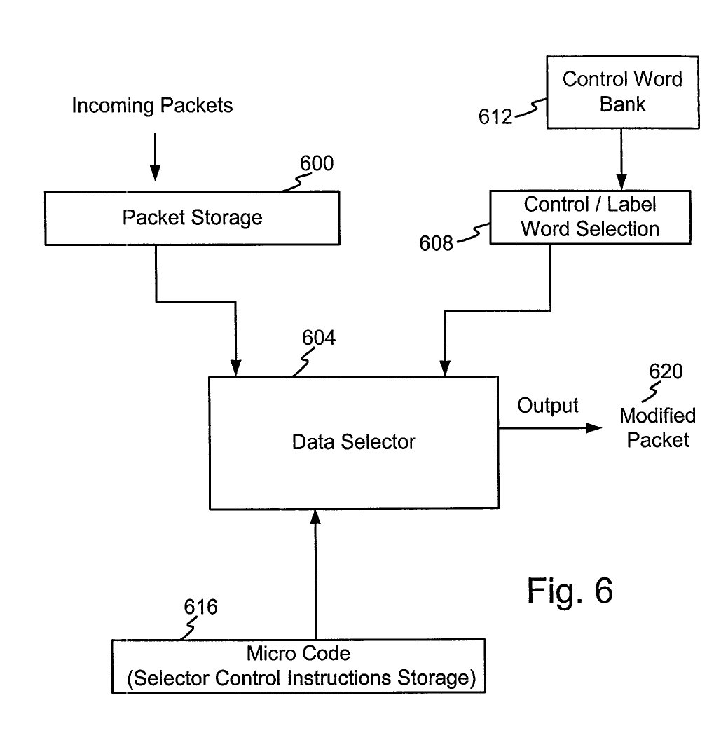

FIG. 6 illustrates a block diagram of an example embodiment of a tag generation system or a general-purpose packet modification system. Generation of a modified packet may be desired to aid or speed routing of a packet. The invention can rapidly generate a tag or produce other programmable packet modifications while providing needed flexibility in tag generation and content. A packet storage area, such as memory 600 or one or more registers, connects to a data selector 604. A control/label storage 608 connects to a control word bank 612. The control word bank 612 may comprise any form of memory or storage system including a first-in/first-out system. The control word bank may be thought of as having a write pointer that is incremented after each write. In one embodiment the write pointer may be pointed to with a counter output. It is contemplated that all memory locations of the control work bank 612 may be read by all pipeline stages concurrently (in a multi-stage processing system) to enable pipelined processing concurrently at more than one stage.

The control word bank 612 stores the one or more control information/labels prior to loading the label into the control/label storage 608. The control/label storage 608 may comprise memory or one or more registers. The control/label storage 608 also connects to the data selector 604. The label comprises any data that may be input into the modified packet. Hence the contents of the modified packet may comprise information from the packet header and information not originally contained in the packet. One example of label data comprises network or protocol specific data.

The selector 604 comprises any type switching device capable of selectively generating as its output one of its one or more inputs. The selector 604 may comprise a multiplexer.

A selector control instruction storage 616 also connects to the selector 604. The selector control instruction storage 616 stores selector control store instructions. The selector control store instructions determine which input the data selector 604 selects as its output to generate as a modified packet. In one embodiment the selector control store instructions are determined based on an analysis of the packet or generated based on a table or CAM look-up. In another embodiment the selector control store instruction are stored in memory and not packet dependent. In one embodiment the selector control instructions comprise micro-code and are generated with the aid of a software program based on a set of dynamic protocol operations used at the network interface. The term control store instruction is defined broadly herein to mean any of the above-described control data or any data configured to guide processing in one or more stage of the packet processing system.

As a result of the processing, modified packet 620 is generated. The modified packet may include a new or modified tag or a new or modified portions of the packet, including the header of the packet. Any type of modification, addition, or subtraction may be performed.

The data selector 604 or another device not shown in FIG. 6 may also be included and configured to modify data as it passes through the data selector. In one embodiment the modification comprises an increment or decrement of a byte of the packet or a portion of the packet. Logic or other hardware may be selectively activated to execute the modifications. The modification may comprise any modification, including, but not limited to a logical operation, including an inclusive or function.

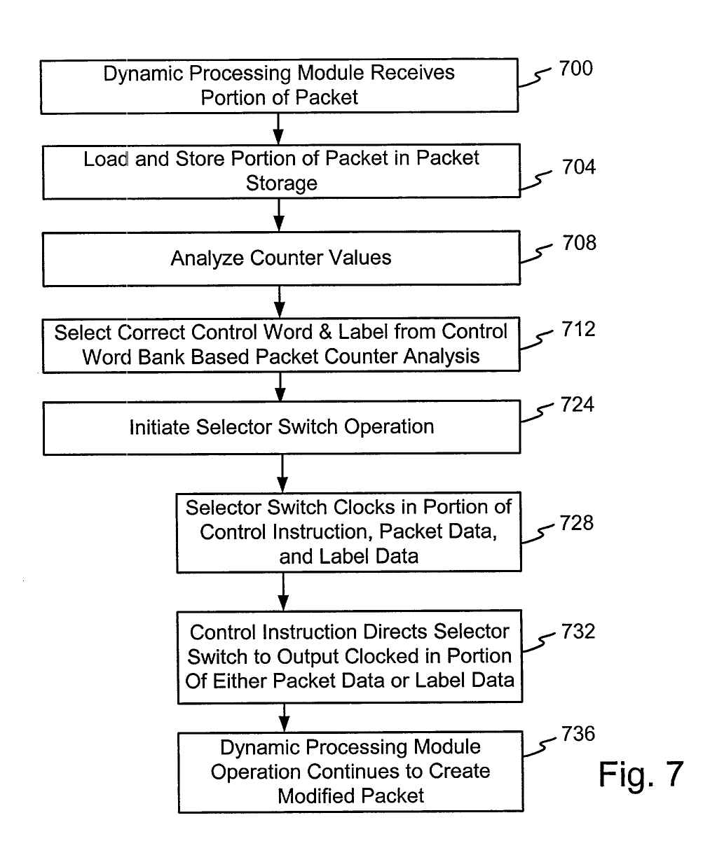

FIG. 7 illustrates an operational flow diagram of an example method of operation of a dynamic processing module. In operation a packet is received by the dynamic processing module at a step 700 and, a portion of the packet may be loaded into packet storage at a step 704. The term packet should be thought of as including a portion of a packet. A packet counter is analyzed at a step 708 to determine which group of control store instructions are to be used to perform the necessary packet modifications. In another embodiment the information necessary for dynamic processing is provided directly to the generation module. After packet counter analysis, the system selects the correct control word and label from the control word bank based on the packet counter analysis. This occurs at a step 712. After the portion of the packet, label and control word are available, the system begins to output portions of a modified packet, which may be modified by adding either a portion of the packet or the label. This occurs at a step 724 by initiating selector operation. The selector control instruction determines which input is selected as the output so that output may occur in any order. Even the packet portions may be re-ordered. ordered. In one embodiment the module operates on or constructs the packet one byte per cycle or one byte at a time. The operation progresses in this manner to construct the tag of the desired data from either of the packet or the label.

An example method of constructing the modified packet is described in steps 728, 732, and 736. Other methods may be adopted without departing from the scope of the invention. At a step 728, the selector clocks in a portion of the control store instruction, the packet data, and the label data. This provides the data available for processing by the dynamic processing module. Next, at a step 732, the control instruction directs the selector to output, as the tag portion, the clocked in portion of either the packet data or label data. In one embodiment, data from the control store instruction may also optionally be utilized to generate the modified packet, such as by utilizing a portion of the control store instruction as output data. At a step 736 the dynamic processing module operation continues to complete generation of the modified packet.

Several advantages are realized by the embodiments of the invention as described above and referenced in FIG. 6 and FIG. 7. One such advantages is that creation of the tag or other packet data modifications can be achieved in a rapid manner. In general the operation of clocking data into the data selector and out of the data selector can occur on each clock cycle without process interruptions which is more rapidly than a microprocessor controlled system of the prior art that may consume numerous clock cycles during each memory read and memory write. Furthermore, multiple bytes/words/double words of data can be manipulated in a single clock and pipelined in such a way as to achieve maximum efficiency. In addition, the above described embodiment of the invention provides the advantage of increase flexibility over hardware only systems due to the use of control store instructions to control the control switch and perform combinations of multiple byte/word/double word operations in a single clock. As a result, the micro code provides flexibility on a data portion by data portion basis. In addition, various different data contained in the packet or the queue associated with the packet can control which of a plurality of different groups of control instructions are selected. Likewise, the invention may retrieve a variety of different labels from memory to selectively incorporate information into the tag.

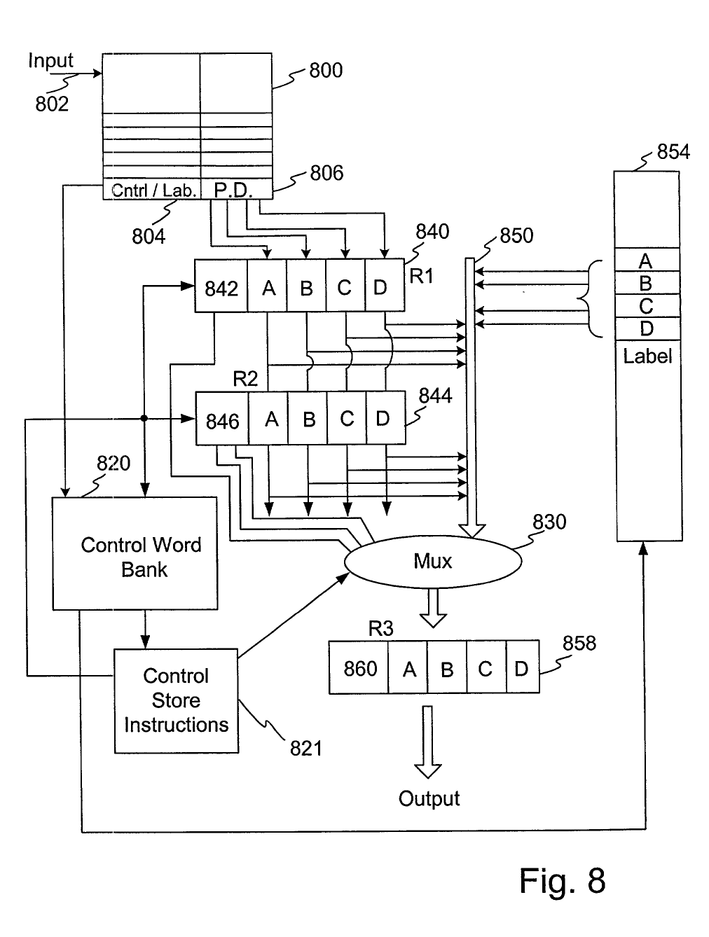

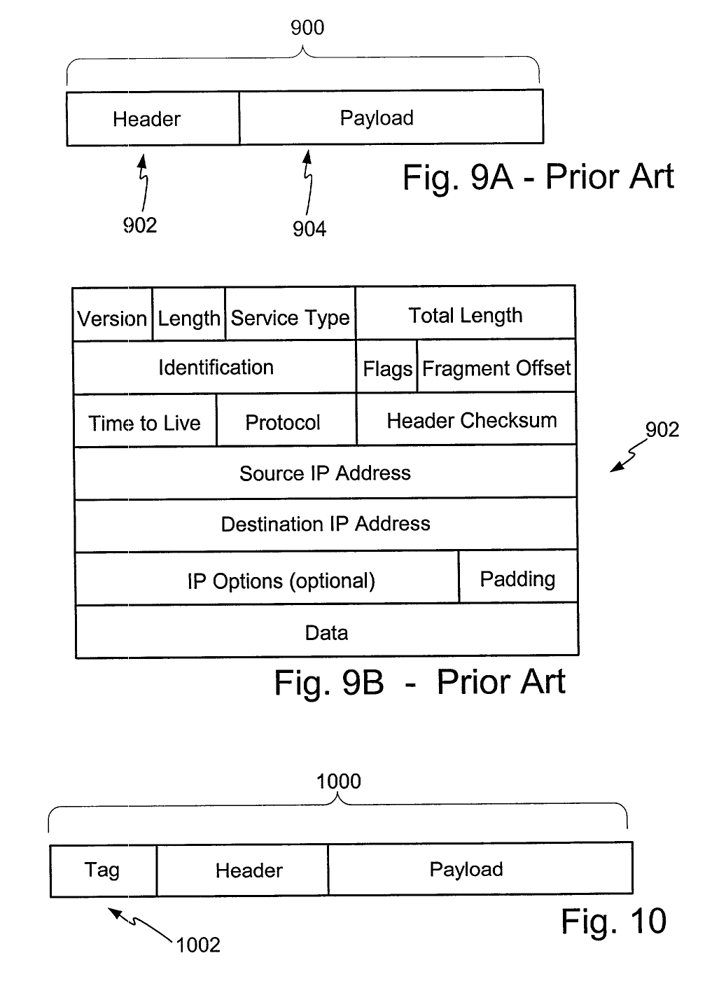

FIG. 8 illustrates an example implementation of one example embodiment of the dynamic processing module. It is contemplated that others of ordinary skill in the art may develop other or alternative embodiments, that while differing in structure do not depart from the scope of the invention as described herein. Although other embodiments may process any type of data, this particular embodiment is particularly designed to processes packets, such as a packet comprised of a header portion and a payload portion. Most often these packets are comprised of a number of bits that are grouped into bytes of data. FIG. 9A illustrates an example of a packet 900 having a header 902 and a payload 904. The packet 900 may comprise a string of bits, often grouped into bytes. Different packet formats or protocols exist such that the header data 902 of different packet protocols is arranged in different order. Example of different packet formats include IPv4 and IPv6. FIG. 9B illustrates an example header 902 having an arrangement of information in a exemplary IP format header. Note that in different formats or protocols the entire header may be of different length, items of information may be arranged in different order, pieces of information in the header may be of different length, or additional items of information may be included. Advantageously the dynamic processing module of the invention is able to dynamically adapt and/or accommodate the various different header formats and the challenges presented by different formats.

FIG. 10 illustrates an example of a packet 1000 having a tag 1002 as created and attached to the front of the packet. The tag 1002 may be attached at any location in relation to the packet. The term tag as used herein means any additional data included with or appended to the packet to aid or speed the routing process, increase network or packet compatibility, or generally aid the routing process.

Returning now to FIG. 8, an example implementation of the tag processing module includes a staging first-in, first-out (FIFO) memory unit 800. An input 802 connects to the FIFO unit 800 to provide packets and control instructions to the FIFO unit 800 and the tag generation module. In the embodiment shown in FIG. 8, the FIFO unit 800 includes control word/label storage 804 and packet data storage 806. In one embodiment the storage 800 contains label data and a dynamic process selector (DPS). The DPS points to a group of control store instructions. This may be considered a dynamic processing program.

Returning now to FIG. 8, the FIFO unit 800 has an output that also connects to a first register R1 840. The registers discussed herein may comprise one register or a plurality of registers to facilitate clocking in, storage and clocking out of information as required for intended operation of the invention. In the embodiment shown in FIG. 8, the first register 840 is configured to store 4 bytes of data received from the FIFO unit 800. The first register 840 also includes a control system or logic 842 to store or manipulate the data including but not limited to information that controls the validity or processing of the information stored in the corresponding register. The logic 842 also connects to a control word bank 820 and the multiplexer 830. The first register 840 has outputs that connect to a multiplexer input bus 850. The multiplexer bus 850 comprises a multiconductor channel connected to the multiplexer 830.

The control word bank 820 comprises storage or memory configured to store two or more control words. The control word bank 820 also connects to a control store instruction storage 821 and the label storage 854. The control words may comprise any size or amount of data and in one embodiment the control word bank is capable of storing six control words, each of which may be independently access by various stages of the pipeline processing system. A packet counter (part of the control systems/logic 842, 846) selects the control word, i.e. control word bank 820 position, to use for processing. The control word, stored in the control word bank 820, specifies a group of control store instructions for the processing stage. A byte counter (part of the control systems/logic 842, 846) selects a control store instruction from the selected group of control store instruction.

A control store instruction storage 821 connects to the logic 842, 846, the control word bank 820, and the multiplexer 830 as shown. The control store instruction storage 821 stores information used on a byte-by-byte basis to select label data, packet data, or both along with the opcode, such as microcode, used to specify how to generate the output bytes for the modified packet. Other control information in the control store instructions includes the byte offset in the packet where data operation is to occur, data mask values (if applicable) and information used to determine how to source data in between packet modifications. One example of information used to determine how to source data in between packet modifications is a continue-word bit. The continue-word bit comprises a item of data or a flag that indicates that data should be passed between stages without processing until the next offset match.

The first register 840 outputs also connect to a second register 844. The second register 844 is generally similar to the first register 840 in construction and operation. In the example embodiment shown in FIG. 8, the second register 844 includes four byte shift registers and associated control system or logic 846. The output of the second register 844 also connects to the multiplexer bus 830 as shown. Control logic, not shown, may reside between the first register 840 and the second register 844 to thereby control data flow between first and second register and the first register and the multiplexer bus 850. Likewise control logic, not shown, may reside between the second register 844 and the other modules in the processing pipeline, the interface systems, or transmit systems to thereby control data or process data flow between the second register 844 and any following modules and the multiplexer bus 850. The logic 846 also connects to the control word bank 820.

A label storage 854 connects to the multiplexer bus 850. The label storage comprises memory, one or more registers, or any data storage area capable of storing data. In one embodiment the label storage 854 is capable of storing a 128 bit label. The label may comprise any type data that is desired to selectively and optionally be utilized for tag data. The label data may be accessed based on the control store instructions in the control word bank 820 and/or the operation of the multiplexer 830.

The multiplexer 830 comprises any switching device capable of selecting an output between a two or more inputs signals or values. In this embodiment, the multiplexer comprises a set of single output, twelve-input multiplexers with a control line connected to the control word bank 820. In one embodiment the multiplexers are replicated across 32 bits of data and individually controllable in byte-wide groups. The control instructions received from the selected group of control store instructions controls which of the twelve inputs each multiplexer 830 provides as an output. It is contemplated that in other embodiments the multiplexer may having any number of inputs or more than one output. The output of the multiplexer 830 connects to a third register 858. The third register is generally similar to the first register 840 and the second register 844. In the embodiment shown, the third register comprises a four byte shift register. Also associated with the third register 858, may be a valid register 860 or control logic configured to store data regarding the validity of the values and an EOP status flag in the third register. The output, over time, of the third register 858 may connect to the next processing module in the packet processing pipeline, an interface, or a transmit system. The output of the third register 858 comprises the possibly modified packet that was originally input into the FIFO unit 800 and a tag attached, modified, or stripped to the packet. The tag may be comprised of any combination of values from the header of the packet, values from the label. It is further contemplated that the dynamic processing module does not have to attach, modify, or strip a tag for every packet. Hence tags may be selectively updated within certain packets.

It should be noted that this is but one exemplary embodiment of the dynamic processing module. It is contemplated that other configurations of pipeline tag processing maybe adopted for use without departing from the scope of the invention.

Exemplary Operation of Dynamic Processing Module

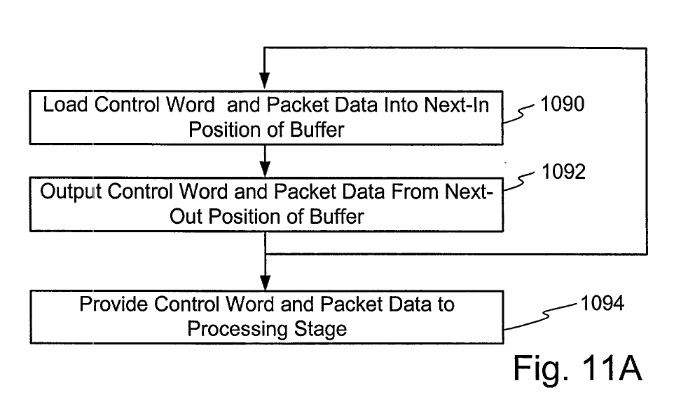

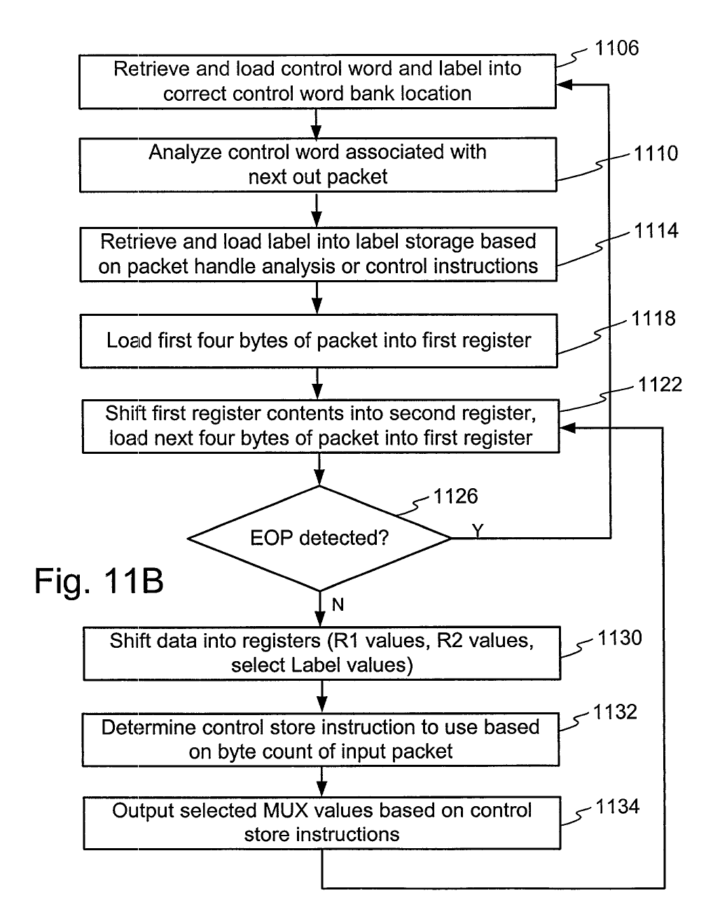

FIG. 11A illustrates an operational flow diagram of an exemplary method of inputting to and outputting to a buffer such as the buffer 510 shown in FIG. 5B. At a step 1090 control data, such as a control word, and packet data is loaded in to the buffer. At a step 1092, control data and packet data is output from the buffer. As shown at a step 1094, the control data and packet data may be provided to a processing stage.

After step 1092, the operation also returns to step 1090 so additional data (control and packet) may be loaded into the buffer is such data is available. In this manner the buffer is continually refilled as data is provided to the processing stages.

FIG. 11B illustrates an operational flow diagram of an exemplary method of operation of the dynamic processing module. It should be understood that this is but one exemplary method of operation. Other methods of use or operation may be contemplated by those of ordinary skill in the art and are within the scope of the invention as broadly defined herein. In the exemplary method of FIG. 11B a memory controller module loads packet data and packet control word(s) into the FIFO unit or buffer. The control word may contain label data. In this example method the dynamic processing module generates, modifies, or removes a tag. The FIFO unit serves as a buffer or hopper. In one embodiment the FIFO unit maintains separate, but associated storage for the packet handle and the packet data. The packet data may include the header and the payload. The packet handle comprises information about the packet, such as including but not limited to the packet format, packet length or type of service. The packet handle may comprise a pointer to the corresponding group of the control instructions.

The control words are generated from information extracted from the packet handle. In one embodiment, as control words arrive at the output of the FIFO, they are stored into a revolving control word bank. The associated packet data that follows the control word out of the FIFO references the corresponding control word for all dynamic processing operations that follow.

Thereafter, at a step 1106, the dynamic processing module accesses one or more control word and label from the control word bank. At a step 1110, the dynamic processing module analyzes the control word that is associated with the next out packet. At a step 1114, the dynamic processing module retrieves and loads a desired label into the label storage based on the control word analysis or the control instructions. In one embodiment the label is selected based on the type or protocol of the packet, the type of the processing to performed, or the queue selection. In one embodiment the label is 128 bits in size. In one embodiment the control instructions contains data to control the location within the label data from which data is provided to the multiplexer as an input. This may optionally be represented as an offset from the first bit of the label data.

At a step 1118, the dynamic processing module continues operation by loading the first four bytes of the packet into the first register. In the embodiment shown in FIG. 8, the first register is configured to accept four bytes at a time. It other embodiments greater than or less than four units of data may be loaded or operated on at a time. Similarly a byte of data is described in this embodiment but in other embodiment any size of data unit may be selected.

At a step 1122 the operation shifts the first register contents into the second register and loads the next four bytes of packet data into the first register. Thus, the first registers is loaded and the second register is loaded and the label data is made available to the multiplexer. At a step 1126 the dynamic processing module detects for an indication of an end of packet (EOP) byte having been loaded into the first register or in some other way detected. An end of packet may be identified by flag.

If at step 1126 the dynamic processing module detects an end of packet indicator, then the operation returns to a step 1102. It is contemplated that every packet may have a different control word and thus requires different processing. Accordingly, new label data and new control instructions can be accessed to appropriately control the output of the multiplexer to create a different tag for the next packet.

If at step 1126 an end of packet is not detected, then the operation progresses to a step 1130. At step 1130 the dynamic processing module shifts the data (R1 values, R2 values, and selected label values) into the switching devices, in this embodiment a multiplexer. At a step 1132, the dynamic processing module determines the control store instruction to use based on the byte count of the packet being processes. As the packet passes through the processing pipeline of the dynamic processing module, one or more counters or other tracking devices monitor the number of bytes that have passed through each stage.

During the next cycle, at a step 1134, the tag generation module outputs the value selected from the R1 values, R2 values, or label values, based on the control store instructions. A shift of the data between registers may optionally occur depending on the needs of the packet processing. In one embodiment the output occurs one byte at a time. In another embodiment the output occur four bytes at a time. After step 1134, the operation returns to step 1122 and the operation continues. In this manner the tag, i.e. multiplexer output, is generated. In one embodiment the process creates only the tag. In another embodiment this process cycles through the entire packet. It should be noted that packet data may be passed through the pipeline process of the tag generation module without change if so directed by the control instructions. It will be appreciated by those of ordinary skill in the art that the dynamic processing module may be controlled to modify header data or any other data within a packet.

Multiplexer Permutations

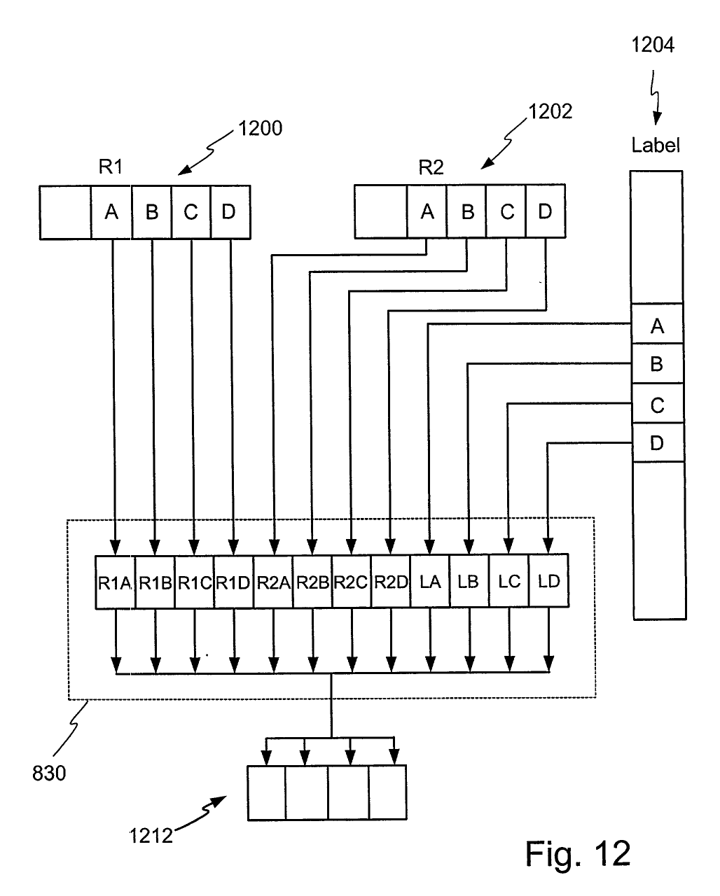

FIG. 12 illustrates the possible outputs of the multiplexer 830 during each cycle of operation. Hence, during an output cycle the multiplexer 830 can output any of its inputs. As shown, during an exemplary output cycle the multiplexer 830 may output one or more of positions A, B, C, or D of the first register 1200, positions A, B, C, D of the second register 1202, or positions A, B, C, or D of the label data 1204. During each output cycle the output may be controlled to output any of the available data into any position of a third register 1212. The control module (not shown in FIG. 12) may connect to the multiplexer 830.

In another embodiment a system for updating, generating, regenerating, calculating, or recalculating portions of a packet or data item are provided. As packet processing occurs through-out the pipeline, it may be desired to employ a static, limited set of packet processing rules to modify a portion of the packet, to recalculate data in the packet, or to update or replace a portion of the packet. One example of such modification may include modification of the time to live (TTL) field in the header. Another example of a modification that may be undertaken is modification or update of the TOS field or the checksum field of the header. Operations on the IPv4, IPv6, or other standard may be performed as necessary. It is contemplated that other aspects of packet processing or other fields in the future may be modified, updated or generated using the principles described below. Hence, the scope of the claims are not limited to update, modification or generate of the particular fields named and described herein, but extends to cover all the principles, systems, and methods as may be contemplated.

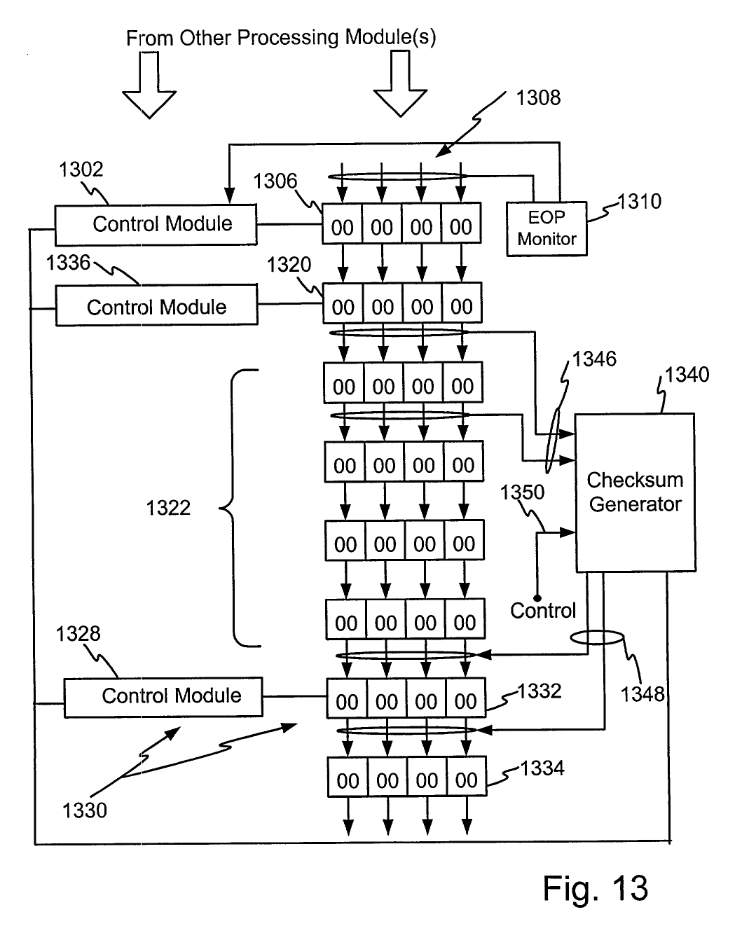

FIG. 13 illustrates a block diagram of an example embodiment. It is contemplated that the embodiment of FIG. 13 maintain a hardware controlled pipelines processing architecture to gain the processing advantages discuss herein. Hence, for purposes of discussion the system shown in FIG. 13 is assumed to receive data (top of the figure) from other processing modules and may pass data (bottom of the figure) to other processing modules.

In the example embodiment shown in FIG. 13, a plurality of pipeline stages or processing apparatus are shown and are configured to achieve checksum generation on an outgoing packet header. A first pipeline stage comprises a control module 1302, and a first register 1306. The first register 1306 receives data over input lines 1308. An end of packet (EOP) monitor 1310 monitors the incoming lines for data that represent the end of a packet. In an alternative embodiment the system may monitor for a start of packet (SOP) indicator. The control module 1302 comprises any type of logic and memory configured to control and monitor the data. In one embodiment the control module 1302 comprises a hardwired set of instructions, selected by a process selector contained in a control word bank location referenced by a packet counter. It is contemplated that the EOP monitor 1310 connects to the control module 1302. The control module 1302 connects or communicates with a checksum generator 1340.

The control module 1302 may comprise a limited set of hardwired control instructions. In this module a control instruction is associated with packet and in part may control the processing at each pipeline stage based on a certain location (offset) in the packet. An offset, such as counter value, from the start of the packet may be used to track which part of a packet is at a particular pipeline stage. Hence, based on the location in a packet and the control instruction selector various modifications, updates, or changes may be made to the packet. In one embodiment the control instruction selector in a control word bank is referenced by a packet counter that updates each time an EOP leaves the pipeline stage, such as with each pipeline stage of data as the pipeline stage of data passes through the pipeline.

In one embodiment the register 1306 comprise a register capable of storing four bytes of data at time. Thus the registers may be thought of as four byte size storage areas. It should be understood that the selection of registers is provided as exemplary. Any size registers or any storage device may be used for storing any size of data.

The output of the first register 1306, and the first control module 1302 feed into a second pipeline stage of similar hardware comprising a second control module 136, and a second register 1320. The first pipeline stage of hardware is configured with outputs that feed into the second pipeline stage of hardware. Additional pipeline stage 1322 may be provided as necessary or desired, and which are described below. Each of the pipeline stage in block of pipeline stages 1322 includes a register or set of registers as described above. In an alternative embodiment the pipeline stages 1322 may be replaced by a single delay or storage device (not shown). It is anticipated that the number or pipeline stages 1322 may vary depending on the particular application.

A pipeline stage 1330 may be similarly equipped as described above. A control module 1328 connects to the register 1332 and to the checksum generator 1340. The control module 1328 is generally similar to control modules 1336, 1302. The output of the register 1332 feeds into a register 1334.

A checksum generator 1340 is included in the system of FIG. 13. In the example embodiment shown, the checksum generator 1340 includes one or more inputs 1346 that connect to the output from the registers as shown. An output 1348 feeds into the input of the register 1332 and into the input of the register 1334. In one embodiment, configured to accommodate packet offset or mismatch, and as shown in FIG. 13, two output line and two input lines are provided. Additional input lines and additional output lines may be provided as necessary and in one embodiment are dependant on the size of the registers and the size of the data that is being modified, updated, or generated. A control input 1350 connects to the checksum generator 1340. In one embodiment the control line 1350 connects to or carries information regarding the EOP or SOP.

The input lines 1346 to the checksum generator 1340 may comprise multiconductor lines configured to communicate or copy the value of the contents of the registers as the data passes into a subsequent register. Similarly the output lines 1348 to the checksum generator may comprise multiconductor lines configured to carry the output of the checksum generator 1340 into one or more registers. The checksum generator 1340 may comprise any adding device which may include firmware, logic, or additional circuits that are configured to maintain a running total or summation of received values. In this embodiment the checksum generator 1340 creates a running total of the value of the bytes in a packet. The use of a checksum for error checking is know in the art and accordingly not described in great detail here. If a packet is modified it may be desired to modify the checksum to account for the modification. Thus an analyzing system will not generate an error signal due to checksum error.

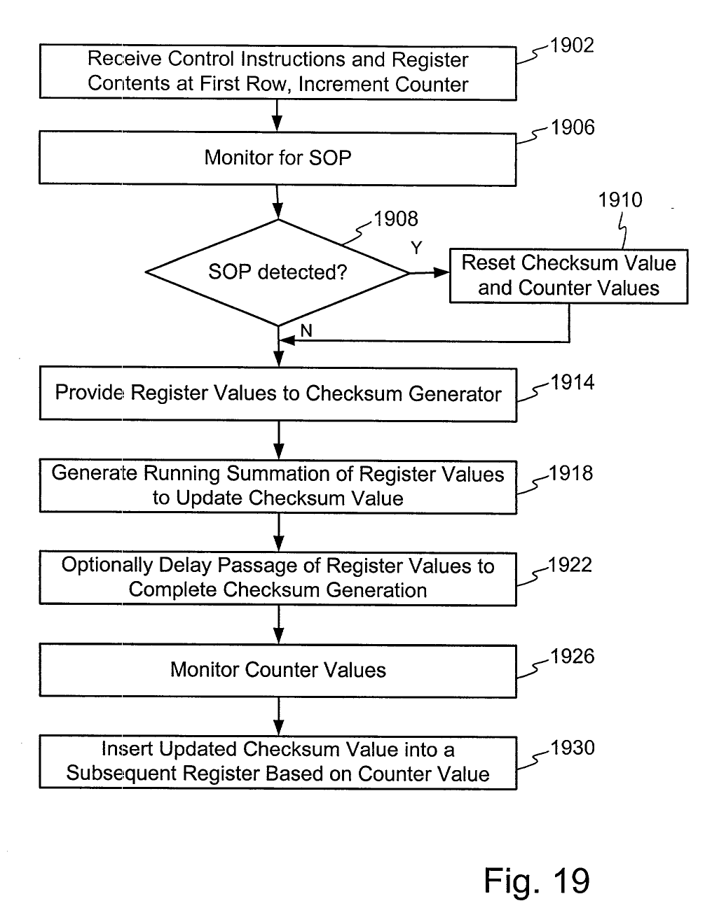

In one general method of operation, a packet header is modified is some manner, a TTL value or type of service (TOS) value is changed or other modification occurs during the processing of the packets. As a result, the checksum value is not longer valid, even though an error has not occurred. As a result, it may be desired to change the checksum values as found in the header. The configuration of FIG. 13 may be used to modify or update the checksum value by, beginning with an EOP or SOP signal, calculating a running summation of the values of the packet as the packet passes through the pipeline. At appropriate offset values, the system is synchronized to insert the newly generated checksum value over lines 1348 into the proper registers 1332 and 1334. A more detailed description of the checksum update process is described below in greater detail in conjunction with FIG. 19. In order to maintain high performance, each pipeline stage can process data on each clock without interruption.

Byte Offset or Byte Offset Mismatch

A discussion of byte mismatch is now provided. In many instances the amount of data added to a packet, such as in the form of a tag, can be of any length depending on the particular process. Thus, as an advantage of one embodiment of the invention, a tag of any length may be added and such length is use selectable and static header fields can still be processed at any modulo-4 bytes offset location. A static header field is a header field that contains data that may be subject to static processing. Certain static header fields within a packet may occur at variable byte offset locations with respect to the beginning of the packet. Because in this embodiment each register comprises a four byte storage system if other than four bytes, or a multiple thereof, are added to the packet, then byte offset mismatch will occur as the packet progresses through the pipeline. The invention is able to adapt and overcome the variable byte offset by tracking the number of bytes that have passed. By handling multiple combinations of variable byte offsets within each 4-byte section of data without shifting data to force a single byte alignment during static processing, the static processing pipeline can push data without interruption. This maintains uninterrupted throughput and avoids performance bottle necks.

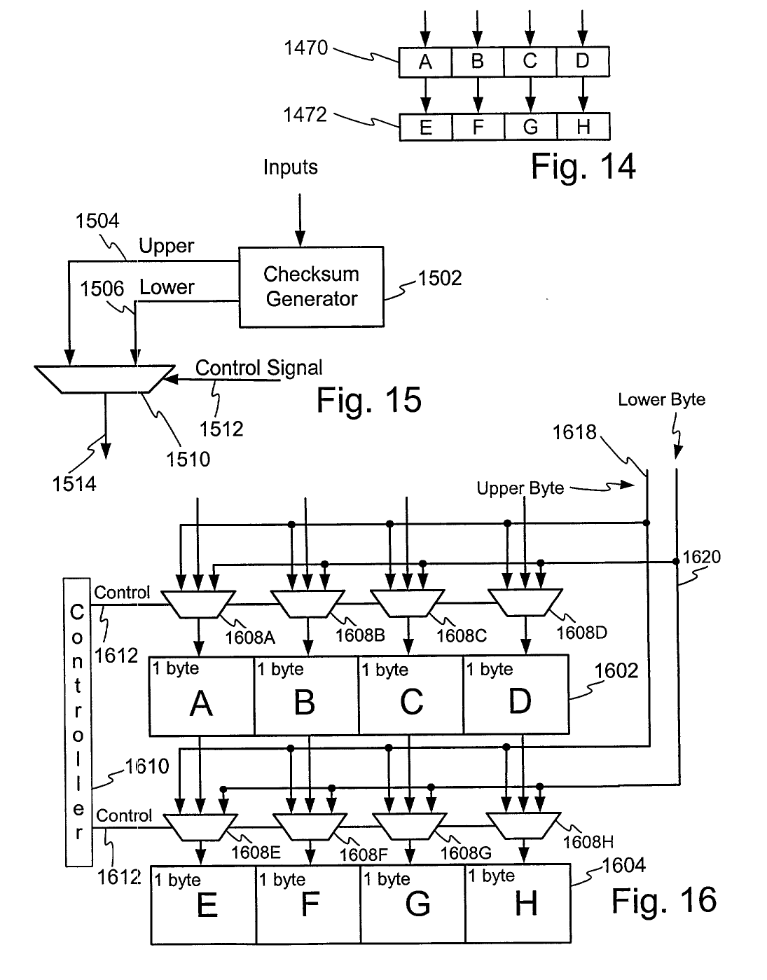

In the particular example of checksum in the current protocols currently in use, the checksum value is two bytes in length. FIG. 14 is provided for purposes of illustration of how a first register feeds into a second register. It shows a four byte register 1470 and a four byte register 1472 where each of the bytes are independently addressable or accessible. Thus, for a packet not suffering from byte mismatch, a two byte value, such as a checksum may consistently fall at a certain location in the registers, such as consistently within positions C and D, and thereafter get clocked into position G and H. However, for a byte mismatch situation and depending on the number of bytes added or subtracted from a packet, the two byte checksum value may fall in positions AB, or BC, or CD, or EF, or FG, or GH. It is also conceivable that the two byte value may reside in position DE. Thus, byte mismatch creates difficulties when attempting to write or re-write over an inaccurate checksum value because the checksum value may fall in any of these two byte locations.

The invention overcomes these difficulties by tracking the location of the desired field, in this example embodiment the checksum field, and/or by tracking the amount of mismatch, which may be referenced as an offset to the checksum value from the start of the packet. The invention is able to multiple header offset values efficiently as the processing is tied to the control word bank and the offset values are provided in the control word bank. Thus, the invention is able to write the checksum value, or any value, of any size and at any location in the packet as the packet passes through the packet pipeline by utilizing the principles of the invention. This process may be made to desirably occur at high speed, such as being enabled in hardware, while being controlled, guided, or supplemented by software control. The software control provides desired user flexibility.

FIG. 15 illustrates an example checksum generator 1502 configured to provide the first byte (upper byte) and the second byte (lower byte) 1506 of the checksum on different lines. These principles may be applied to devices configured to generate or manipulate values other than a checksum or to have additional inputs or additional outputs, such as to accommodate a three or more byte output value. In reference to FIG. 15, the upper byte output 1504 and a lower byte output 1506 both connect to a switch or multiplexer 1510. The multiplexer 1510 includes an control signal input 1512 and an output 1514.

In operation, the checksum generator 1502 outputs the first byte of the checksum value on the upper line 1504 and the second byte of the checksum value on the lower line 1506. The control signal on control line 1512 selects the output of the multiplexer 1510 from either the inputs on the upper line 1504 or the lower line 1506. In this manner the output of the multiplexer 1502 may be controlled and hence the input to a particular byte location A-H of a register may be controlled and selected between the upper byte or the lower byte. It is also contemplated that a data pass through is available so that the value of the byte location as it passes through the pipeline is not changed.

FIG. 16 illustrates an implementation example of the system of FIG. 15. As shown a first register 1602 and is configured in relation to a second register 1604. In the embodiment shown the registers are four bytes wide with each byte being independently addressable. Associated with each byte section of the first register 1602 and the second register 1604 is a multiplexer 1608A-1608D and 1612E-1612H. The output of each multiplexer 1608A-1608D and 1608D-1608H feeds into its corresponding byte section of a register. Each register receives input from a lower byte line 1620, a upper byte line 1618, and the proceeding register. A control line 1612 connects to each multiplexer 1608A-1608E and 1608D-1608H to control which input to the multiplexer is selected as the output.

In operation, byte mismatch is accommodated by selectively controlling which multiplexer 1608A-1608D and 1608E-1608H is enabled to provide as its output the lower byte of the checksum value and the upper byte of the checksum value. By way of example, if byte mismatch occurs causing the upper portion of the checksum value to be in register position 1602D and the lower portion of the checksum value to be in register position 1604E, then the control lines 1612, 1612 control multiplexer 1608D to output the upper byte value to register positions 1602D and control multiplexer 1608E to output the lower byte in the register position 1604E. The other multiplexers 1608A-1608C and 1608F-1608H maybe controlled to pass through the value stored in the corresponding byte section of the proceeding register. In other example degrees of byte mismatch, the multiplexers 1608A-1608D and 1608E-1608H may be controlled in any manner to achieve the desired register inputs.

TTL/TOS

In one embodiment of pipeline processing it may be desirable to modify the TTL value or the TOS value. As is understood, a time to live (TTL) field may be placed in a header of a packet and set to an initial value. At each stop in the packet's trek, the packet's TTL value is decremented. When the TTL value is decremented to zero, a packet processing device, such as a router, may drop the packet. However it may be desired to refresh, reset, or modify a data item's (such as a packet) TTL field. It another example it may be desired to modify a packet's type of service field (TOS). It is contemplated that it may be desired to change other fields of a packet header or tag entries other than those fields recited herein. The invention includes the flexibility to change any portion of a packet in any way desired. As an advantage such flexibility may be controlled via a user interface with assistance of a CPU or other processor. Operation of at least a portion of the system occurs using high speed hardware with a data pipeline optimized for updating the TOS field of an IPv4 header and processing data at each pipeline stage on each clock edge. Thus, some degree of software flexibility is achieved without degrading high speed hardware operation.

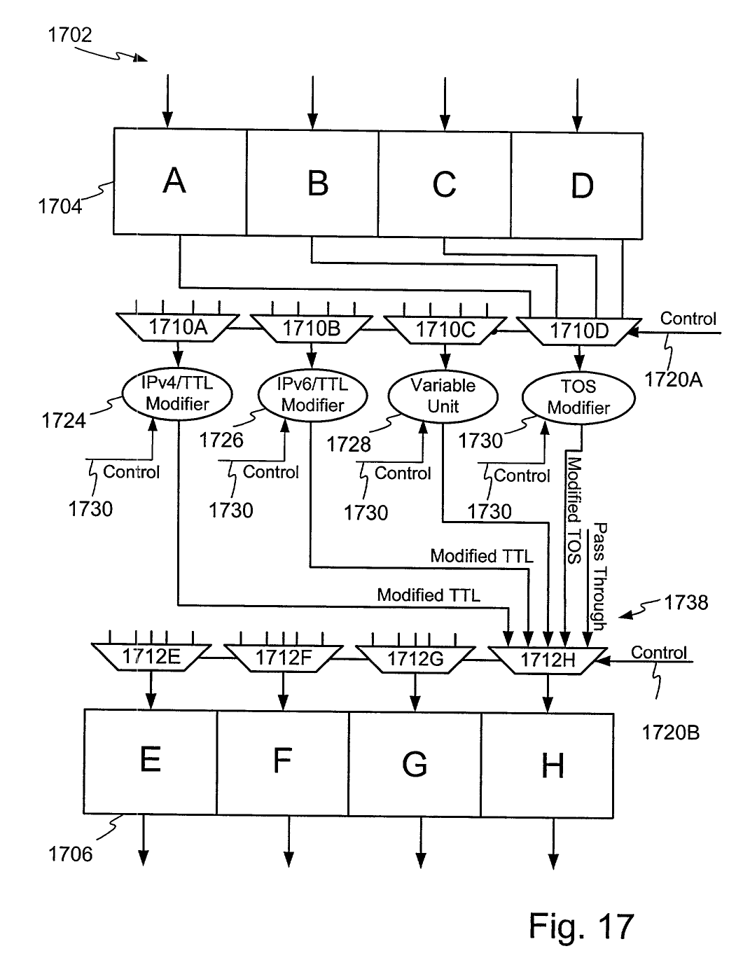

FIG. 17 illustrates an example embodiment of a field modifier system 1702 as is contemplated for use with a pipeline processing system that can process new data on each clock without interruption to the constant flow of data through the pipeline. In this embodiment a first register 1704 receives input from a prior stage of the system while a second register 1706 resides subsequent to the first register. The first and second registers 1704 and 1706 may be of any size, type, configuration or width as desired and need not be the first and second registers in the pipeline. The term register as used herein in intended to mean a storage device and hence any storage, memory device, or basic logic may serve as a register.

In the example embodiment shown in FIG. 17, the register 1704 receives input from a prior or parallel system and has output connected to a subsequent system in the pipeline or to output processing. In this example embodiment the registers 1704 and 1706 store four bytes of data, one byte per section. Register 1704 has sections A, B, C and D while register 1706 has sections E, F, G, and H.

Also shown is a first bank of multiplexers or switches 1710A-1710D and a second bank of multiplexers or switches 1712E-1712H. Although not shown, it is contemplated that each multiplexer 1710A-1710D in the first bank have a connection layout of that of multiplexer 1710D and multiplexer 1712H. FIG. 17 does not show the layout of lines of each multiplexer so that the figure does not become undesirable confusing. Thus, each section A, B, C, D of the register 1704 connects to a each of the multiplexes 1710. For example, the output of register 1714A connects to an input of multiplexer 1710A-1710D. Via this connection pattern, each multiplexer 1710A-1710D receives input from each register 1704. A control line 1720 connects to each multiplexer. It is contemplated that each multiplexer be independently controlled. The control line 1730 may connect to and receive control signals from a control module. A signal on the control line 1720 selectively controls which input the multiplexers provide as an output.

The output of the multiplexers 1710connects to processing logic 1724, 1726, 1728, and 1730. It is contemplated that any type processing logic or processing module may receive the output from the multiplexer. The processing logic 1724, 1726, 1728, and 1730 may comprise specialized systems or general logic. In the example embodiment shown in FIG. 17, the processing logic comprises a IPv4/TTL modifier 1724, a IPv6/TTL modifier 1726 available modification unit 1728, and a TOS modifier 1730. The IPv4/TTL modifier 1724 is configured to change the value of the TTL field for packets or headers organized under the IPv4 standard. The IPv6/TTL, modifier 1726 is configured to change the value of the TTL field for packets or headers organized under the IPv6 standard. TOS modifier 1730 is configured to change the value of the TOS field for the of a packet. Any type modification or change may be made as may be contemplated as the invention is not limited to any one particular change or modification. A desirable feature of the invention is its ability to concurrently process at high speed data in the pipeline and account for different location of data due to byte mismatch. Each modifier may include a control signal to further adapt or enable the modifier as desired.

An additional variable modifier unit 1728 is shown as receiving the output of byte section C. The variable modifier unit 1728 may assume any modification desired and it is further contemplated that control signals be input to the variable modifier unit 1728 to selectively control the operation performed on its input. Hence it is contemplated that modification other than modifications to the TTL field and the TOS field may occur. Likewise, it is further contemplated that a change or modification to the type of processing performed by the variable modifier unit 1728 may occur.

The output of the modifiers 1724, 1726, 1728, and 1730 feed into second bank of multiplexer or switches 1712E, 1712F, 1712G, 1712H. In one embodiment each of the multiplexer in the second bank of multiplexers receives as an input the output from the processing logic of the modifiers 1724, 1726, 1728, and 1730 and a pass through signal on line 1738. As with the first multiplexer bank, only an exemplary connection is shown and it is contemplated that each of the outputs of the modifiers 1724, 1726, 1728, and 1730 be connected to each of the multiplexers 1712E, 1712F, 1712G, 1712H in the second bank of multiplexers.

Based on control signals received on control line 1720B the second bank of multiplexers may selectively output any of the input signals. The output of the multiplexers 1712E, 1712F, 1712G, 1712H feed into the corresponding byte sections E, F, G and H of the second register 1706. The output of the second register 1706 may feed into a subsequent processing state or output processing. It should be noted that this but one embodiment.

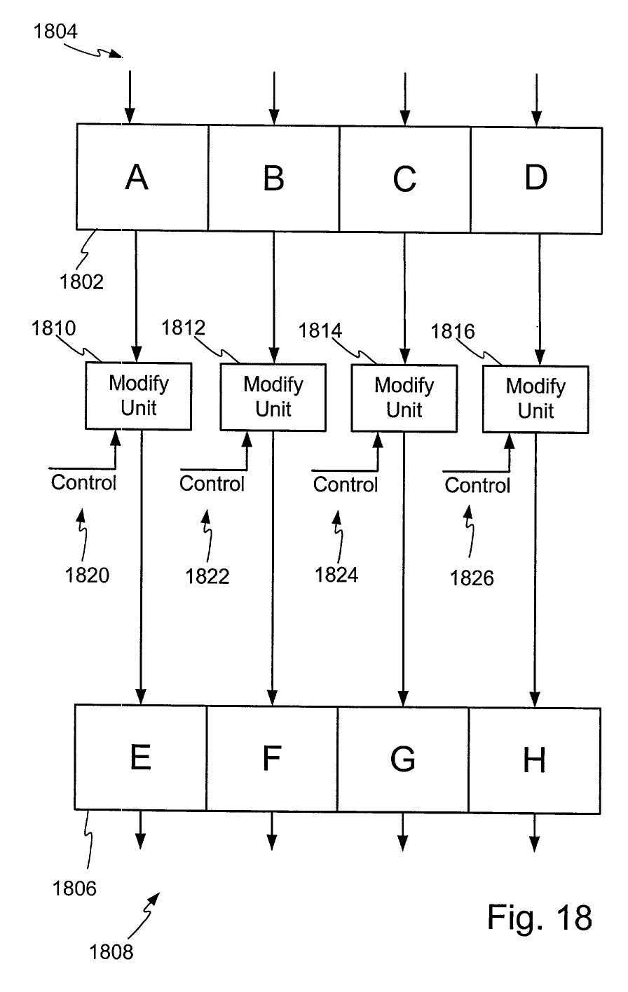

FIG. 18 illustrates an alternative embodiment having a generally similar first register 1802 with inputs 1804, second registers 1806 with outputs 1808, and intermediate processing. Likewise, this embodiment can also process data on each clock without interrupting data flow to thereby achieve the highest performance. In the example embodiment of FIG. 18, intermediate processing comprises one or more modify units 1810-1816. Each modify unit 1810-1816 may optionally include a control Line 1820-1826 to selectively carry control signals to the modify units. In this embodiment each modify unit 1810-1816 connects to the proceeding register and the subsequent register. However, it is contemplated that each modify unit 1810-1816 may be configured to execute any of a number of different type processes. For example, based on control signals, carried on control lines 1820-1826, each modify unit may perform TTL modification for a IPv4 type packet, a IPv6 type packet, a DiffServ type packet or any other type or protocol of packet. Moreover, it is contemplated that any of the modify units may perform any modification in addition to or other than TTL modification. It is further contemplated that the processing that occurs in the modify units 1810-1816 may be controlled or set at least in part or entirely by software interface or user interface over the control lines 1820-1826. Thus flexibility is provided by user control, configuration, and setup, yet final operation may occur at high speed primarily, partially, or entirely in hardware. While the reduction of routing lines and reduction of multiplexers/switches over the embodiment of FIG. 17 can be appreciated, this embodiment requires duplicate hardware in the modify unit 1810-1816 if all potential types of modification or processing is to occur in each modify unit.

FIG. 19 illustrates a flow diagram of an example method of operation. This is but one example methods of operation and it is contemplated that other method of operation may be implemented by one of ordianary skill in the art that do not depart from the scope of the invention as described herein. The overall method of operation may be characterized as detecting a start of a packet or tag and then generating a running summation of a checksum or any other error checking value. At the appropriate spot in the packet, the updated error checking value is insert into the packet.

In the exemplary method shown in FIG. 19, at a step 1902, the system receives control instructions and data, referred to as register contents, at a first row or first storage device of the system. As data is received, a counter may also be incremented. The control instruction may provide data regarding location in a packet and/or type of packet instructions on how to process. The counter may be used to determine the offset, from the start of the packet. A counter value may also be used to provide a pointer to a memory location. At a step 1906, the operation monitors for a Start of Packet (SOP) identifier or an EOP identifier. If at a step 1908 the system detects an SOP the system, at a step 1910, resets the checksum value and the value that specifies a byte location in a packet. This signifies the start of a packet and hence is desired to reset these values. After the reset process the operation progresses to a step 1914 wherein the system provides the register values to a checksum generator. In other embodiments any operation may occur that continually or periodically monitors the packet values or progress. At a step 1918, the system generates a running summation of register values as the packet data progresses down the packet pipeline. This generates an updated checksum value. It is contemplated that data continue to be processed in this manner.

At a step 1922, the system may optionally delay or pass the data through an extended portion of pipeline to allow time for the checksum generator to complete the processing of the updated checksum. Thereafter, simultaneously, or prior thereto, the system may monitor the counter values to determine, based on a known offset location of the checksum value from the start of the packet, the location of the checksum value in subsequent registers. This occurs at a step 1926. Base on the counter value and any byte mismatch the checksum may be inserted into the proper section of the packet. FIGS. 14, 15, 16 illustrate on example system for inserting the upper byte of an error checking value into one particular register section and inserting the lower byte of an error checking value into another particular register section. At a step 1930, the system may optionally insert the updated checksum value into a subsequent register base on the counter value and other control signals. It is contemplated not every packet passing through the packet processing pipeline will require checksum or other error code updating.

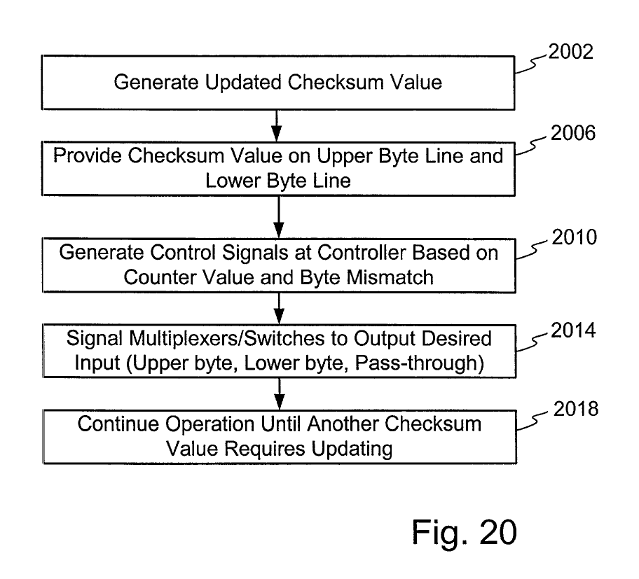

FIG. 20 illustrates an exemplary flow diagram of an example method of byte selection for data insertion. This is but one example method as may be based on the system of FIGS. 14, 15, 16. Other methods of operation exist and may be enabled that do not depart from the scope and contemplated breadth of the claims. This method provides means to selectively insert values, of any size, into one or more sections of a register or packet. At a step 2002, the operation generates an updated checksum value to be inserted into an appropriate spot in a packet, such as to replace an existing checksum value. Next, at a step 2006, the operation provides the two byte checksum value on the upper byte line and a lower byte line. In one embodiment these lines connect to an input of a multiplexer or switch. At a step 2010, a controller generates control signals based on counter values and an amount of byte mismatch. These control signals control multiplexers or switches to pass one of one or more inputs to an output and hence into a subsequent register or storage device. This occurs at a step 2014. At a step 2018, the operation may continue operation by passing packets through the pipeline and monitoring for signals that indicate when another checksum value requires updating. One example of when a checksum value may require updating is when the packet has been modified or a tag added.

The examples shown describe how the invention could be used to process fields of an IP header. The methods described to modify these fields are not restricted to IP protocol fields, they may be applied to modify packet, cell or frame header, trailer, or payload fields in a data unit of any type network protocol, including but not limited to IPv4, IPv6, ATM, Fibre Channel, Ethernet, Infiniband or the like. Other uses are also contemplated.

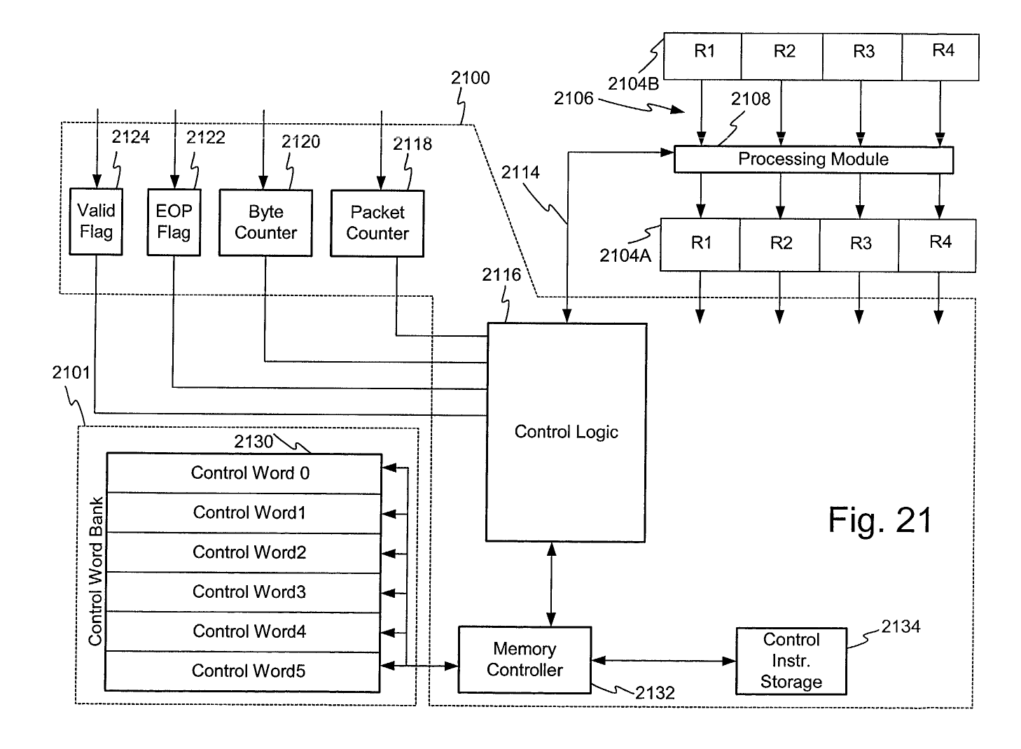

Turning now to a more detailed description of the control system, FIG. 21 provides an exemplary embodiment of an example configuration of a control system. Other embodiments are contemplated and it is not considered that a different embodiment will depart from the scope of the invention. The system enclosed within the dashed line may be considered the distributed portion 2100 of the control system in that is associated in some form with one or more individual stages of the processing pipeline, and may be duplicated at each stage. The portion within dashed line 2101 is the centralized portion of the control in that it is located at one or more locations and shared by the other processing systems and control systems 2100. It is contemplated that a distributed portion of the control system is replicated at each pipeline stage in the various processing modules. The control system 2100 may be configured to associated with each stage of storage units or registers or a single control unit may be provided.

In FIG. 21, a storage unit 2104A or register is shown to aid in understanding how the control system 2100 may interface with the storage units. The storage unit 2104A includes register byte positions R1, R2, R3, R4. Input may be provided to the storage unit 2104 via input lines 2106. The input lines 2106 may be monitored or the inputs provided to other locations as shown. Output from the storage unit 2104 occurs via output lines 2112. The input to the storage unit 2104 may arrive from other aspects of a data processing system or from a previous storage unit or register, such as register 2104B. It is contemplated that prior and/or subsequent stages of register, such as register 2104B may have distributed control systems, such as system 2100, associated therewith. Likewise, the output of the storage unit 2104A may be provided to a subsequent storage unit or other aspects of a pipeline processing system.

Although shown before the storage unit 2104, a processing module 2108 may also be provided after the storage unit. The processing module 2108 may optionally be included to perform desired processing on the data passing into or out of storage units. The processing module 2108 is described in more detail above, and hence such a discussion is not repeated again. It should be understood that when equipped with a processing module 2108 the processing module may perform processing on the particular data provided to it from proceeding registers and based on the information from the control module 2100.

Control word bank 2130 also connect to or are included within the control module 2100 as shown. In this embodiment the control word bank 2130 stores control words that guide operation of the control module 2100 and the processing module 2108. The control word bank 2130 may comprise a memory, such as random access memory, and/or a content addressable memory (CAM) or other look-up device but to achieve high performance and process multiple pipeline operations at the same time the device must have multiple read ports. In one embodiment the control word bank 2130 comprises a bank of registers written like a FIFO, but with all locations visible or readable to external logic, such as a pipeline stage, in parallel. Due to the fact that multiple control words are readable, multiple pipeline stages can perform operations based on different control words in parallel, thus optimizing performance. It is contemplated that the control word bank 2130 store a plurality of control words and various other types of information as may necessary to process the packet as described herein. In one embodiment the control word bank 2130 optionally stores 32 bits of data or 128 bits of data for use in processing depending on the particulars of a packet or data item and the type of processing or manipulation being performed on the packet. Operation of the control word bank 2130 is described in greater detail below as it relates to the control module L100.

In reference to the control module 2100, a description is now provided in logical relation to operation of the control module. A data line 2114 connects to the processing module 2108. The data line 2114 may comprise a multi-conductor line that is configured to provide the data from each register location R1, R2, R3, R4 of the control word bank 2130 to the control module 2100 and provide data from the control module to the register locations. The data line 2114 may also provide data to other aspects of the control module 2100 as shown.

Control logic 2116 connects to the data line 2114. The control logic 2116 may comprise configuration of logic, comparators, input/output registers and the like configured to control input to and output from the processing module 2108 and the other aspects of the control module 2100. Based on the control terms provided to the processing module 2108 from the control module the processing module may execute various different processing on the data.

A packet counter 2118, byte counter 2120, an end of packet (EOP) 2122, and a valid flag 2124. The control logic 2116 also connects to a control word bank 2130 that is configured to store a plurality of control word. The control logic 2116 connects to the control word bank 2130 through a memory interface 2132. Although any number of control word may be stored in the control word bank 2130, the embodiment of FIG. 21 includes six storage location, each of which may be independently accessed by the control logic 2116. The memory interface 2132 provides or facilitates communication between each of the control word bank 2130, the control logic 2116, and the control instruction storage 2132. A packet counter 2118 at each pipeline stage is used to select or identify the appropriate control word for that stage.

The packet counter 2118 comprises a counter or other tracking device configured to serve as a pointer to a memory location in the control word bank 2130. Hence, in one embodiment the packet counter 2118 comprises an six position counter able to point the control logic to one of the six control words stored in the control word bank 2130. The packet counter 2118 is initial set to zero and is incremented each time an end of packet (EOP) information is detected. The output of the packet counter may be thought of as being associated with a location in the control word bank where a particular control word is stored that is associated with the packet passing through the processing module.

The byte counter 2120 comprises a counter or other tracking or counting device configured to count the number of bytes or other unit of data that have passed though the processing module since the prior counter reset. At start-up or receipt of new packet the byte counter 2120 is set at zero. By incrementing the counter for every byte of a packet that passes through the a pipeline stage, such as the processing module, an offset or location within the packet may be determined. The output of the byte counter 2120 is provided to the control logic 2116 to thereby provide packet offset information to the control logic so that the control logic may provide control store instructions from storage 2134 and data to the processing module 2108 at the appropriate position in the packet. If data useful in processing the packet is not available in the control word stored in the control word bank 2130, then a data read or access to the control store 2134 may be necessary. The storage 2134 stores control store instructions that are used to provide supplemental data for processing or to direct processing of the packet.

The EOP flag 2122 stores a flag that indicates when an end of packet has been detected. This information may be important during the processing and can be used as a packet counter and byte counter reset signal.

The valid flag 2124 stores data indicating whether the data or information passing through the processing module 2108 is valid data that should be processed or acted upon. For example, in some instances the data being clocked through the processing module, i.e. through the pipeline, may simply be blank or fill data, or no data at all, such as when there are no packets to be processed. As a result, the valid flag 2124 indicates that the contents of the storage unit 2104 or the data entering the storage unit is not valid and hence processing should not be performed thereon. The valid flag 2124 may be reset or changed as required when valid data is provided to the processing module 2104. The packet counter, byte counter, EOP flag, valid flag and other distributed control logic may be replicated at each pipeline stage used to process data. The specific control logic for each stage may vary according to the processing requirements for each stage.

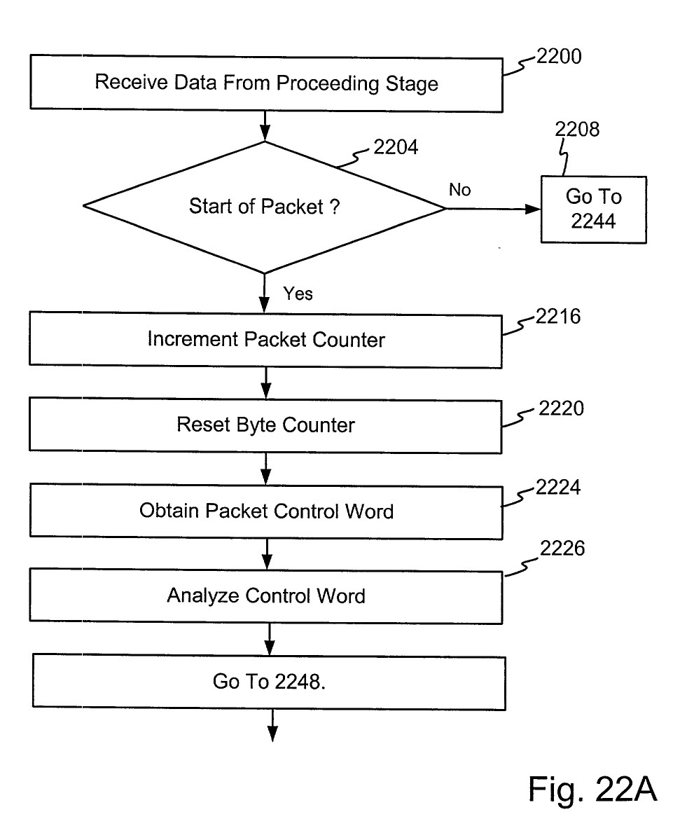

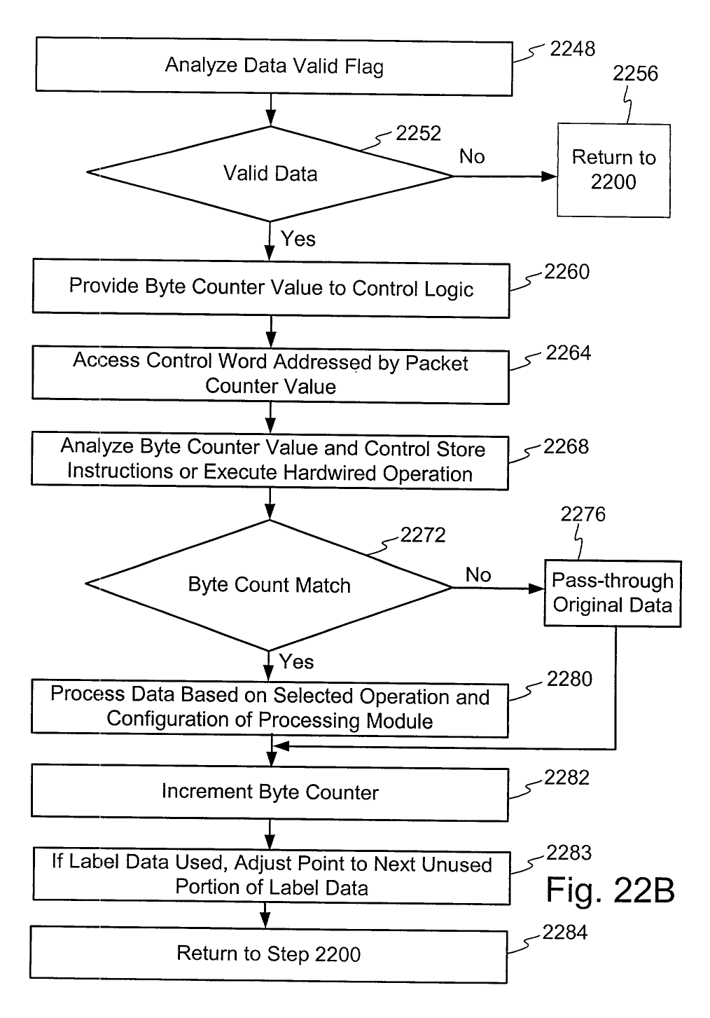

Operation of the control module 2100 and its associated apparatus is now described in the example environment of a pipeline processing arrangement. FIG. 22 illustrates an operational flow diagram of an example method of operation of one example embodiment of a control module or the control apparatus of a pipeline processing stage. This is but one example method of pipeline processing control and as such the scope of the claims is not intended to be limited to this particular method. Before moving to the particulars of FIG. 22, a general discussion of the operation is provided. In general, the control module 2100 operates to provide data to the processing module 2104 and initiate or cease processing module operation. Via the control logic, detectors, counters, and memory access, the control module 2100 monitors or tracks which bytes of a packet are stored in or entering the storage unit that is associated with the control module. In this manner the processing of the packet is controlled. Different operations may be executed based on hardwired controls or the control store instruction associated with the packet or data may be inserted into the packet, such as data from the control store instruction based on the packet control word and the byte location within the packet.

In reference to FIG. 22A, at a step 2200 the processing stage receives data from the proceeding stage of the processing pipeline. Of course, if the current processing stage is the first processing stage then the data would be received from some other system. In this example embodiment the packet is received by each stage four bytes at a time. After or concurrently with receiving the data, which will be referred to as a packet for this discussion, the processing stage determines if the start or end of a packet was received. This may occur by monitoring an EOP flag or an SOP flag. If at step 2204 the data received is not the end of the packet then the operation advances to a step 2208. Step 2208 is a jump point to step 2244, which is described below in greater detail in conjunction with FIG. 22B.

If at step 2204 the data received indicated it was the end of a packet or the start of the packet, then the operation advances to a step 2212 and the processing stage obtains a packet handle or other information regarding the packet. This may be obtained from a different processing stage or determined based on analysis of the packet header. The packet handle may contain information regarding the protocol of the packet, processing parameters, data for tag generation, one or more addresses for additional packet processing data stored in memory, or any other processing information.

Concurrently or sequentially with receipt of the end of a packet several other events may occur. At a step 2216 and a step 2220, the processing stage increments the packet counter and resets the byte counter. In this embodiment the packet counter output provides an address or pointer to a control word in the control word bank. The control word contains information or provides a pointer or address to information that will guide or control the processing of the packet in the stage. The byte counter comprises a counter that indicates the location within a packet, on a byte-by-byte or word-by-word basis, that is stored in the current processing stage. The byte counter may be considered as providing an offset from the start of the packet. The offset may be necessary so that the processing performed by a particular stage may be performed on the proper data in the packet as the packet passes through the processing stage(s). The packet control word may be analyzed at some point, a step 2224, to determine processing at the state and to determine if additional data, such as label data contained in the control word, may be necessary during the processing at the stage. For example, in one embodiment additional data may be required to generate a tag or to guide processing. At a step 2226 the system analyzes the control word 2226 to determine processing parameters.

After step 2226, the operation advances to a step 2248, shown on FIG. 22B. In reference to FIG. 22B, at step 2248 the operation analyzes the valid flag. A flag, which indicates the validity/invalidity of the data, is associated with data passing into the processing stage. At a step 2252 the processing state determines the validity of the data. If the data is not valid, no further processing need be performed and the operation advances to a step 2256. At step 2256 the operation returns to step 2200 to await receipt of data from a proceeding stage or system.

If at step 2252 the data is determined to be valid then the operation advances to a step 2260 and the byte counter value is provided to the control logic. As a result, at a step 2264 the control module accesses the control word provided at the address or pointer value specified by the packet counter value. This control word will guide processing. At a step 2268 the control module analyzes the byte counter value and the control word to determine what processing, if any, to perform on the data currently in the processing stage. For example, in the case of checksum modification only the portion of the packet, i.e. the bytes, that actually contain the checksum values will be modified. Similar packet location selection must be made for TTL and TOS modifications. At a step 2272 a decision is made based on the analysis regarding whether there is a byte count match between the byte counter and a next byte count of the control word. If there is not a match the operation advances to a step 2276 wherein the data is passed through. In some instances when there is not a match, processing is not performed on the data. After step 2276, the operation advances to a step 2282, described below. If the decision at step 2272 there is a match, then the operation advances a step 2280 wherein the system processes the original data based on the operation of the pipeline stage (processing module) and the control word.

Next, at a step 2282, the operation increments the byte counter to account for new data being clocked through the pipeline stage. At a step 2283, if the label is used for processing, the operation adjusts the label pointer to the next unused portion of the label data. If label data is used, the adjustment may be made based on the number of label bytes used. Thereafter, at a step 2284, the operation returns to step 2200 to repeat this stage of the processing operation.

It should be noted that this is but one possible method of operation of a control module configured to guide operation of the processing stages. In various other embodiments other methods and apparatus may be implemented to guide device operation without departing from the scope of the invention as defined below by the claims.

It will be understood that the above described arrangements of apparatus and the method therefrom are merely illustrative of applications of the principles of this invention and many other embodiments and modifications may be made without departing from the spirit and scope of the invention as defined in the claims.

We claim:

1. A control system for controlling operation of a pipelined packet processing system having two or more stages, wherein each of the two or more stages may process a different portion of a packet and packets are being sequentially processed in the pipeline processing system, the control system comprising:
a control word bank having two or more locations, the locations in the control word bank configured to store control words such that each packet is associated with a control word;
a packet counter having an output, the packet counter output comprising an address to a location in the control word bank;
a byte counter having an output, the byte counter output comprising an offset in the packet at which processing on the packet is occurring;
a control module configured to receive the packet counter output, the byte counter output, and access the control word bank to thereby selectively provide data to at least one stage of the pipelined packet processing system to control processing of the packet in the at least one stage.

2. The control system of claim 1, wherein to control processing of the packet comprises controlling which portions of the packet are processed.

3. The control system of claim 1, further configured to access control store instructions and wherein the packet counter and the byte counter is associated with each of the two or more stages.

4. The control system of claim 1, wherein the pipeline processing system is configured to add, modify or strip data from a packet.

5. The control system of claim 1, further including a multiplexer control system comprising multiplexer control logic and multiplexer control instruction memory, wherein control logic is configured to control operation of one or more multiplexers based on the multiplexer control instructions stored in the multiplexer control instruction memory.

6. The control system of claim 1, wherein the pipelined processing system is configured to attach a tag comprised of tag data to the packet, the tag data being obtained from the control word associated with the packet, a label, a control store instruction, any combination of the control word, label, or control store instruction

7. The control system of claim 1, wherein the control word bank has a write pointer that is incremented after each write.

8. The control system of claim 1, further including memory configured to store a label, the label being accessible by the control module.

9. A control system for a packet processing system with multiple stages, each stage receiving a portion of a packet at a time, the control system comprising:
a processing location tracking system configured to generate tracking data regarding which portion of a packet a stage is processing;
a control word storage having two or more storage locations configured to store two or more control words;
control word identification system configured to provide a pointer to a location in the control word storage;
an interface configured to selectively provide tracking data and control word data stored at a location identified by the pointer to a stage.

10. The control system of claim 9, further including an end of packet monitor configured to reset the processing location tracking system and modify the control word identification system upon detection of an end of a packet.

11. The control system of claim 9, further including a valid data monitoring system configured to enable operation of a stage if the portion of the packet at a stage is valid data.

12. The control system of claim 9, further including supplemental data storage in communication with the interface or a stage, the supplemental data storage configured to store supplemental data for use in processing a packet.

13. The control system of claim 9, wherein the tracking system comprises a counter configured to increment with passage of a portion or a part of a portion of a packet and the tracking data comprise an output from the counter.

14. The control system of claim 13, wherein a portion of a packet comprises four bytes of data.

15. The control system of claim 13, wherein a portion of a packet comprises two or more bytes of data and a part of a portion comprises a byte of data.

16. The control system of claim 13, wherein the supplemental data comprises a label for use in generating a tag.

17. The control system of claim 9, wherein the control word identification system comprises a counter configured to increment upon passage of a packet through a stage.

18. The control system of claim 9, wherein a control word comprises data that at least partially controls processing of the packet.

19. The control system of claim 18, wherein the control word is 144 bytes in size.

20. A method for controlling when a processing module will perform processing as a packet passes through a packet processing pipeline, the method comprising:
resetting a counter having an counter output upon detection of a new packet received at the processing module;
incrementing the counter upon passage of portions of the packet;
comparing a portion of control data associated with the packet to the counter output;
initiating operation of the processing module if the comparing reveals a match between the portion of the control data and the counter output.

21. The method of claim 20, wherein the comparing is performed by a hardwired comparator.

22. The method of claim 20, wherein the portion of the control data comprises data defining an offset from the start of the packet at which processing on the packet is to occur.

23. The method of claim 20, further including:
analyzing the packet to determine a packet protocol; and
selecting control data based on the packet protocol.

24. The method of claim 23, wherein the packet protocol consists of IPv4, DiffServe IPv4, and IPv6.

25. The method of claim 20, wherein the method occurs in a plurality of processing module in a plurality of packet processing pipelines in a packet router.

26. The method of claim 20, further including:
incrementing a second counter upon receipt of the new packet, the second counter having an output comprising an address to a memory;
storing the control data in the memory at the address generated by the second counter; and
providing the address to the processing module to thereby direct the processing module to the control data associated with the packet being processed by the processing module.

27. A method for controlling tag generation in a dynamic processing module, the tag to be associated with a packet, the method comprising:
storing a control word at an address defined by a control word selector, the control word being associated with a packet;
storing control store instructions in memory;
passing portions of a packet through a dynamic processing module;
tracking the passing of portions in relation to an offset from the first portion of the packet;
selectively supplementing the packet by adding data from the control word as the packet passes through the dynamic processing module, the supplementing occurring at locations in the packet based on the tracking and the control store instructions.

28. The method of claim 27, wherein the control word selector comprises a counter configured to increment upon receipt of a new packet by the dynamic processing module and the output of the control word selector comprises the address.

29. The method of claim 27, wherein portion comprises a byte.

30. The method of claim 27, wherein tracking comprises resetting a counter upon receipt of a new packet and incrementing the counter as portions of the packet pass through the dynamic processing module.

31. The method of claim 27, wherein the dynamic processing module is implemented in hardware.

32. The method of claim 27, wherein the tag is an MPLS type tag.

33. The method of claim 27, wherein the control store instructions control at what offset from the start of the packet the dynamic processing module will generate tag data.

34. A method for selecting between two or more control words when processing a packet at each processing stage as the packet passes through a packet processing pipeline, the method comprising:
receiving the packet at a processing stage in a packet processing pipeline;
modifying the output of a tracking system upon receipt of the packet at the processing stage;
storing a control word at one of two or more locations in a control word bank, the one of the two or more locations defined by the output of the tracking system;
providing the tracking system output to the processing stage, wherein the tracking system output selects which control word the processing stage will use.

35. The method of claim 34, wherein more than one processing stage concurrently utilizes the same control word due to the packet being concurrently processed by more than one processing stage and the control word comprises between 1 byte and 2048 bytes of data.

36. The method of claim 34, wherein the processing stage comprises a dynamic processing module or a static processing module.

37. The method of claim 34, wherein the tracking system comprises a counter associated with the processing stage, the counter configured to increment upon receipt of packet or upon the end of a packet at the processing stage.

38. The method of claim 34, further including storing associated packets and control words prior to entry of a packet into the processing pipeline.

39. A method for controlling data flow between storage locations in a pipeline processing system, the method comprising:
storing data in a first storage location;
reading control data from a first memory;
providing the control data to a data processing stage;
transmitting data from the first storage location to the data processing stage;
processing the data at the data processing stage based on the control data to create processed data; and
transmitting the processed data based on the control data to any of a plurality of second storage locations.

40. The method of claim 39, wherein transmitting the processed data is performed by multiplexer.

41. The method of claim 39, further including:
transmitting the processed data to a second data processing stage;
providing second control data to the second data processing stage;
processing the processed data with the second data processing stage based on the second control instructions.

42. The method of claim 39, wherein the first and second storage locations comprise data registers.

43. An apparatus for controlling one or more packet modification systems in a pipeline processing system comprising:
means for identifying a portion of a packet that is in a modification system;
means for identifying a control word for use by the one or more modifications systems, the control word providing data to the one or more modification systems to control operation of the one or more modification system;
means for storing the control word;
means for interfacing the means for identifying a portion of a packet, means for identifying a control word, and means for storing the control word with one or more modification systems.

44. The apparatus of claim 43, further including:
means for detecting an end of a packet, said means for detecting used by the means for identifying a portion of a packet and the means for identifying a control word to account for a new packet.

45. The apparatus of claim 43, wherein the means for identifying a portion of a packet and the means for identifying a control word comprises counters.

46. The apparatus of claim 43, further including means for inhibiting modification system operation when invalid data is in the modification system.

47. The apparatus of claim 43, further including means for storing a label in communication with the interface, the label comprising data for use in tag generation.

48. A control system for a data processing module comprising:
a first memory location configured to store supplemental data
a second memory location configured to store data selector control data;
a third memory location configured to store packet data;
a data selector in communication with the first memory location, the second memory location and the third memory location, the data selector configured to selectively output either packet data or supplemental data based on the data selector control data.

49. The system of claim 48, wherein the supplemental data comprises data to be associated with the packet data as a tag.

50. The system of claim 48, further including a buffer configured as a first-in, first-out memory location to store packet data and control data, the buffer further configured to provide stored packet data to the data processing module and provide control data to the first memory location.

51. The system of claim 48, further including forth memory configured to store additional supplemental data that is communicated to the data selector instead of the supplemental data.

52. The system of claim 48, wherein data selector comprises a multiplexer configured to output packet data and supplement data to thereby generate a modified packet.
